(19) United States
(12) Patent Application Publication
(10) Pub. No.: US 2026/0056482 A1
(43) Pub. Date: Feb. 26, 2026

(54) IMAGE FORMING APPARATUS AND PROCESS CARTRIDGE

(71) Applicant: FUJIFILM Business Innovation Corp., Tokyo (JP)

(72) Inventors: Fuyuki KANO, Kanagawa (JP); Yoichi KIGOSHI, Kanagawa (JP); Yuki OYAMADA, Kanagawa (JP); Kohei TAKAOKA, Kanagawa (JP); Kenta IDE, Kanagawa (JP)

(73) Assignee: FUJIFILM Business Innovation Corp., Tokyo (JP)

(21) Appl. No.: 19/043,531

(22) Filed: Feb. 3, 2025

(30) Foreign Application Priority Data
Aug. 23, 2024 (JP) 2024-143458

(51) Int. Cl. G03G 5/05; G03G 5/047; G03G 21/00; G03G 21/18

(52) U.S. Cl. CPC G03G 5/0546; G03G 5/047; G03G 5/0564; G03G 21/0011; G03G 21/1814; G03G 2215/00957; G03G 2215/00962

(57) ABSTRACT

An image forming apparatus includes an electrophotographic photoreceptor in which a conductive substrate, a charge generation layer, and a charge transport layer are laminated in this order, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, a transfer device that transfers the toner image to a surface of a recording medium, and a cleaning device that has a cleaning blade for cleaning the surface of the electrophotographic photoreceptor with a contact line pressure of 2.4 gf/mm or more and 4.5 gf/mm or less, in which the charge transport layer contains a binder resin containing at least a polyarylate resin having a dicarboxylic acid unit represented by Formula (A) and a diol unit represented by Formula (B) and a polycarbonate resin, and a charge transport material.

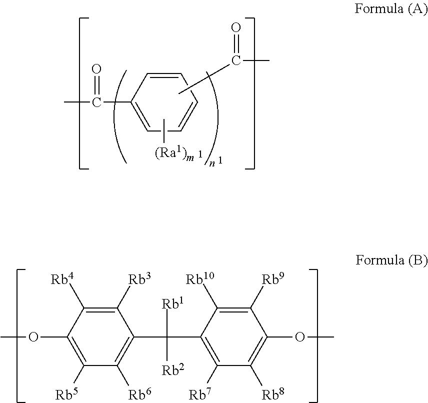

In Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms.

In Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

### CROSS-REFERENCE TO RELATED APPLICATIONS

This application is based on and claims priority under 35 USC 119 from Japanese Patent Application No. 2024-143458 filed Aug. 23, 2024.

### BACKGROUND

### (i) Technical Field

The present invention relates to an image forming apparatus and a process cartridge.

### (ii) Related Art

JP2003-005607A discloses “image forming apparatus including a cleaning device that scrapes off a toner attached to an image carrier, in which an elastic cleaning blade is brought into contact with the image carrier at a contact pressure of 0.147 N/cm or more and 0.588 N/cm or less in order to scrape off the toner attached to the image carrier, and a surface layer of the image carrier contains fluorine-based resin particles and a specific polyarylate resin”.

JP1996-286510A discloses “image forming method including developing a toner image on a photoreceptor and transferring the toner image onto a transfer member so that an image is formed, in which a residual toner on the photoreceptor is cleaned with a cleaning blade, a coefficient of friction between the photoreceptor and the cleaning blade is 1.0 or less, an angle formed between the cleaning blade and the photoreceptor is 18° or more, and an intrusion of the cleaning blade into the photoreceptor is 0.7 mm or more”.

JP2003-005606A discloses “image forming apparatus including a cleaning device that brings a cleaning blade into contact with a rotating image carrier to remove a developer on the image carrier, in which the image carrier has a surface layer containing fluorine-based resin particles and a specific polyarylate resin, an angle α between a line connecting a contact position between the cleaning blade and the image carrier and a center of the image carrier and a line connecting a highest point of the image carrier with respect to a horizontal plane and the center of the image carrier is 0°≤α≤90° on a downstream side in a rotation direction of the image carrier, and a contact angle β between a tangential direction of the image carrier at the contact position between the cleaning blade and the image carrier and the horizontal plane of the cleaning blade is 0°<β≤90°”.

### SUMMARY

In an image forming apparatus including a cleaning device that cleans a surface of a lamination-type electrophotographic photoreceptor containing a polyarylate resin in a charge transport layer with a contact line pressure of 2.4 gf/mm or more and 4.5 gf/mm or less, an increase in rotational torque and a decrease in fine wire reproducibility may occur. In a case where the rotational torque is excessively increased, the image forming apparatus tends to have a short life due to poor rotation.

Aspects of non-limiting embodiments of the present disclosure relate to an image forming apparatus in which abrasion resistance is excellent even in a medium- to long-term use and an increase in rotational torque is suppressed, as compared with a case where a binder resin of a charge transport layer is composed of only a polyarylate resin.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific methods for achieving the above-described object include the following.

According to an aspect of the present disclosure, there is provided an image forming apparatus including:
an electrophotographic photoreceptor in which a conductive substrate, a charge generation layer, and a charge transport layer are laminated in this order;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that has a cleaning blade for cleaning the surface of the electrophotographic photoreceptor with a contact line pressure of 2.4 gf/mm or more and 4.5 gf/mm or less,
in which the charge transport layer contains a binder resin containing at least a polyarylate resin having a dicarboxylic acid unit represented by Formula (A) and a diol unit represented by Formula (B) and a polycarbonate resin, and contains a charge transport material,

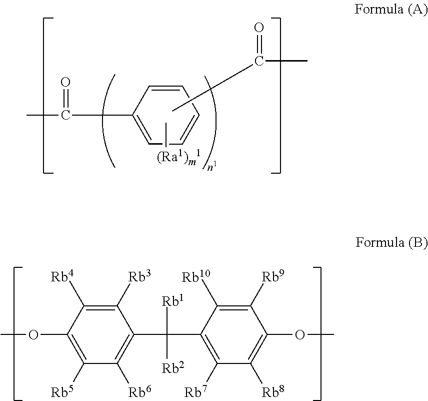

in Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to a first exemplary embodiment;

FIG. 2 is a view schematically showing the configuration of an example of an image forming apparatus according to the present exemplary embodiment;

FIG. 3 is a view schematically showing a configuration of another example of the image forming apparatus according to the present exemplary embodiment; and

FIG. 4 is a schematic view showing an installation condition of a cleaning blade to a member to be cleaned in the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, the term “(meth)acryl” may denote any of “acryl” or “methacryl”.

In the present disclosure, an alkyl group is any of linear, branched, or cyclic, unless otherwise specified.

Hereinafter, an electrophotographic photoreceptor will be referred to as “photoreceptor”.

### Image Forming Apparatus

The image forming apparatus according to the present exemplary embodiment includes an electrophotographic photoreceptor in which a conductive substrate, a charge generation layer, and a charge transport layer are laminated in this order, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, a transfer device that transfers the toner image to a surface of a recording medium, and a cleaning device that has a cleaning blade for cleaning the surface of the electrophotographic photoreceptor with a contact line pressure of 2.4 gf/mm or more and 4.5 gf/mm or less, in which the charge transport layer contains a binder resin containing at least a polyarylate resin having a dicarboxylic acid unit represented by Formula (A) and a diol unit represented by Formula (B) and a polycarbonate resin, and a charge transport material.

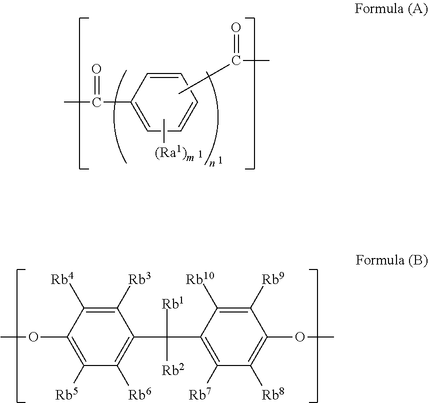

In Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms.

In Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

In the related art, an image forming apparatus including a lamination-type photoreceptor containing a polyarylate resin in a charge generation layer has high hardness of the charge generation layer and has excellent abrasion resistance. However, in order to improve cleaning properties of a surface of the photoreceptor, in a case where a contact line pressure of the surface of the photoreceptor at a contact portion with a cleaning blade is increased (for example, the contact line pressure is 2.4 gf/mm or more), a rotational torque is likely to increase. Therefore, the cleaning blade has a short life, and the surface of the photoreceptor is likely to be abraded in the medium- to long-term.

In the image forming apparatus according to the present exemplary embodiment, the charge generation layer contains the polyarylate resin having the dicarboxylic acid unit represented by Formula (A) and the diol unit represented by Formula (B). In the polyarylate resin, resin molecules are bonded to each other by intermolecular forces due to stacking of aromatic rings, and thus the polyarylate resin has a rigid skeleton in which aromatic rings are repeated. Therefore, the abrasion resistance is excellent even in long-term use.

In addition, in the image forming apparatus according to the present exemplary embodiment, the charge generation layer contains a polycarbonate resin in addition to the polyarylate resin. As a result, a sea-island structure in which the polyarylate resin having high hardness and the polycarbonate resin having high sliding properties are included is formed in the charge generation layer. Therefore, a contact pressure of the cleaning blade with respect to the surface of the photoreceptor is appropriately dispersed and easily stabilized. As a result, the abrasion resistance is excellent even in a medium- to long-term use, and an increase in rotational torque is suppressed. In addition, in the image forming apparatus according to the present exemplary embodiment, the contact line pressure is 4.5 gf/mm or less, and thus excessive pressurization of the surface of the photoreceptor by the cleaning blade is suppressed. Therefore, a contact pressure of the cleaning blade with respect to the surface of the photoreceptor is appropriately dispersed and easily stabilized. As a result, the abrasion resistance is excellent even in a medium- to long-term use, and an increase in rotational torque is suppressed.

From the above-described points, it is considered that the image forming apparatus according to the present exemplary embodiment has excellent abrasion resistance even in long-term use and the increase in rotational torque is suppressed.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a charge erasing device that erases the charges on the surface of the electrophotographic photoreceptor by applying the charge erasing light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

That is, the process cartridge according to the present exemplary embodiment is a process cartridge including an electrophotographic photoreceptor in which a conductive substrate, a charge generation layer, and a charge transport layer are laminated in this order, and a cleaning device that has a cleaning blade for cleaning a surface of the electrophotographic photoreceptor with a contact line pressure of 2.4 gf/mm or more and 4.5 gf/mm or less, in which the charge transport layer contains a binder resin containing at least a polyarylate resin having a dicarboxylic acid unit represented by Formula (A) described above and a diol unit represented by Formula (B) described above and a polycarbonate resin.

An example of the image forming apparatus according to the present exemplary embodiment will be shown below, but the present invention is not limited thereto. Hereinafter, among the parts shown in the drawing, main parts will be described, and others will not be described.

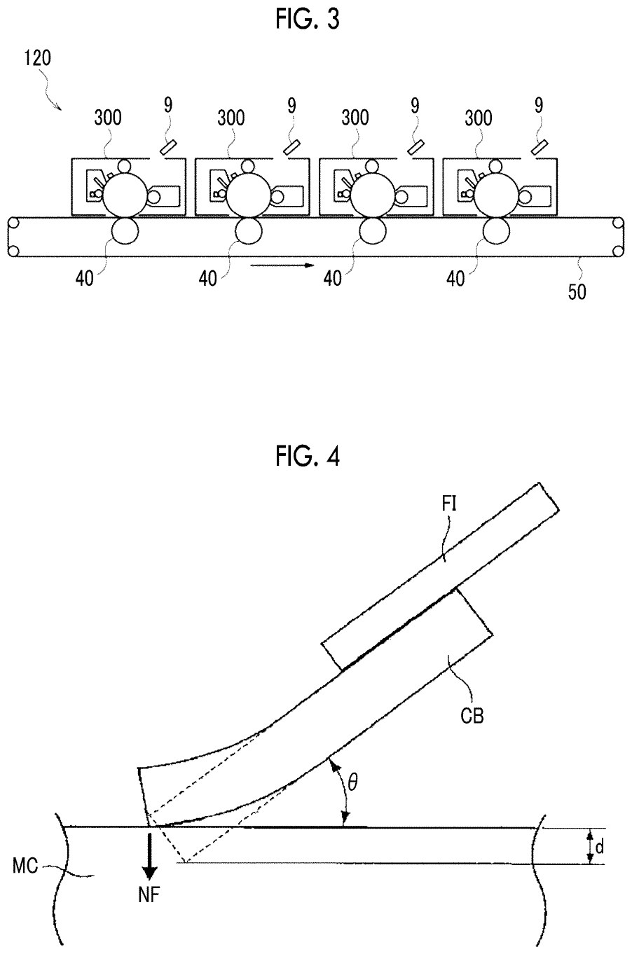

FIG. 3 is a view schematically showing a configuration of an example of the image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade 131 that cleans the surface of the electrophotographic photoreceptor 7 with a contact line pressure of 2.4 gf/mm or more and 4.5 gf/mm or less, and the cleaning blade 131 is disposed to be in contact with the surface of the electrophotographic photoreceptor 7. In addition, in the cleaning device 13, a cleaning member that is a conductive or insulating fibrous member may be used in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Cleaning Device

As the cleaning device 13, a cleaning blade-type device including the cleaning blade 131 that cleans the surface of the electrophotographic photoreceptor 7 with a contact line pressure of 2.4 gf/mm or more and 4.5 gf/mm or less is used.

In addition to the cleaning using the cleaning blade-type device, a fur brush cleaning method or a simultaneous development cleaning method may be adopted.

The cleaning blade may have, for example, a single-layered configuration, a two-layered configuration, a configuration of three or more layers, or other configurations as long as the contact portion with the photoreceptor having the above-described physical properties is provided.

Examples of the cleaning blade having a single-layered configuration include a cleaning blade configured such that the entire cleaning blade including the contact portion with the photoreceptor is formed of a single material (that is, a cleaning blade consisting of a contact member).

Examples of the cleaning blade having a two-layered configuration includes a cleaning blade provided with a first layer that includes the contact portion with the photoreceptor, is formed over the entire surface on a belly side, and consists of a contact member, and a second layer that serves as a back surface layer formed on a back surface side of the first layer and consists of a material different from the material of a contact member.

Examples of the cleaning blade having a configuration of three or more layers include a cleaning blade having another layer between the first layer and the second layer in the above-described cleaning blade having a two-layered configuration.

The cleaning blade is used, for example, by being bonded to a rigid plate-like support material.

The contact line pressure of the cleaning blade with respect to the surface of the electrophotographic photoreceptor 7 is 2.4 gf/mm or more and 4.5 gf/mm or less, and is, for example, preferably 2.6 gf/mm or more and 4.0 gf/mm or less, and more preferably 3.0 gf/mm or more and 3.5 gf/mm or less.

In a case where the contact line pressure of the cleaning blade is 2.4 gf/mm or more, a residual toner on the surface of the electrophotographic photoreceptor is further suppressed from being falling off, and thus the cleaning properties are further improved.

In a case where the contact line pressure of the cleaning blade is 4.5 gf/mm or less, excessive pressure on the contact portion between the surface of the electrophotographic photoreceptor and the blade is suppressed, and thus the abrasion resistance of the surface of the electrophotographic photoreceptor is more excellent even in the medium- to long-term use. In addition, curling of the cleaning blade is easily suppressed, and the cleaning properties are further improved.

The contact line pressure of the cleaning blade with respect to the surface of the electrophotographic photoreceptor 7 may be 3.0 gf/mm or more or 4.0 gf/mm or more.

In a case where the contact line pressure of the cleaning blade is set to 3.0 gf/mm or more (particularly 4.0 gf/mm or more), excessive pressure is applied to the contact portion between the surface of the electrophotographic photoreceptor and the blade, and the rotational torque is likely to increase. In addition, the surface of the electrophotographic photoreceptor is likely to be abraded in the medium- to long-term use. However, in the image forming apparatus according to the present exemplary embodiment, since the specific polyarylate resin and the polycarbonate resin are contained as the binder resin of the charge generation layer, even in a case where the contact line pressure is in the above-described range or more, the increase in rotational torque is suppressed, and the abrasion resistance is excellent even in the medium- to long-term use.

A micro rubber hardness of the contact portion of the cleaning blade, which comes into contact with the surface of the electrophotographic photoreceptor, is, for example, preferably 78° or more, more preferably 85° or more and 94° or less, and still more preferably 85° or more and 92° or less.

In a case where the micro rubber hardness of the contact portion is 78° or more (for example, more preferably 85° or more), a hardness of the contact portion of the cleaning blade with respect to the surface of the photoreceptor is relatively low, the cleaning blade is curled, and the decrease in cleaning properties is further suppressed.

In a case where the micro rubber hardness of the contact portion is 94° or less, the hardness of the contact portion of the cleaning blade with respect to the surface of the photoreceptor is relatively high, and the excessive increase in contact line pressure is suppressed, and the increase in rotational torque is further suppressed.

The micro rubber hardness of the contact portion is a value measured by MD-1 manufactured by KOBUNSHI KEIKI CO., LTD.

The micro rubber hardness of the contact portion can be controlled by, for example, a method of adjusting a material of the contact portion of the cleaning blade (for example, a method of adjusting a proportion of isocyanate blended in polyurethane rubber, a method of performing an impregnation treatment with isocyanate, or the like).

### Formulation of Contact Member

A formulation of the contact member constituting the cleaning blade is not particularly limited, and a formulation having the above-described preferred physical properties is preferable.

Examples of the contact member include a member containing a polyurethane rubber.

### Polyurethane Rubber

The polyurethane rubber is polyurethane rubber obtained by polymerizing at least a polyol component and a polyisocyanate component. In addition to the polyol component, the polyurethane rubber may be, as necessary, polyurethane rubber obtained by polymerizing a resin having a functional group capable of reacting with an isocyanate group of polyisocyanate.

For example, the polyurethane rubber preferably includes a hard segment and a soft segment. The term “hard segment” denotes a segment in which, among polyurethane rubber materials, a material constituting the hard segment is relatively harder than a material constituting the soft segment; and the term “soft segment” denotes a segment in which, among polyurethane rubber materials, a material constituting the soft segment is relatively softer than a material constituting the hard segment.

Examples of the material constituting the hard segment (hard segment material) include a low-molecular-weight polyol component as the polyol component, and the resin having a functional group capable of reacting with an isocyanate group of polyisocyanate. On the other hand, examples of the material constituting the soft segment (soft segment material) include a high-molecular-weight polyol component as the polyol component.

Here, an average particle diameter of aggregates of the hard segment is, for example, preferably 1 μm or more and 10 μm or less, and more preferably 1 μm or more and 5 μm or less.

In a case where the average particle diameter of the aggregates of the hard segment is 1 μm or more, frictional resistance of the surface of the contact member is likely to be reduced. Therefore, the behavior of the blade is stable, and local wear is likely to be suppressed.

On the other hand, in a case where the average particle diameter of the aggregates of the hard segment is 10 μm or less, the occurrence of chipping is likely to be suppressed.

The average particle diameter of the aggregates of the hard segment is measured as follows. By using a polarizing microscope (BX51-P manufactured by Olympus Corporation), an image is captured at a magnification of 20, and image processing is performed to convert the image into a binary image. For each of 20 cleaning blades, particle sizes (equivalent circle diameters) of aggregates are measured at 5 spots (at each spot, particle sizes of 5 aggregates are measured), and an average particle diameter of the 500 aggregates is calculated.

The binarization of the image is carried out by adjusting threshold values of hue, chroma, and brightness using image processing software OLYMPUS Stream essentials (manufactured by Olympus Corporation) such that the color of the aggregates in the crystal part and the hard segment is black and the color of the aggregates in the amorphous part (corresponding to the soft segment) is white.

### Polyol Component Examples of the Polyol Component Include a High-Molecular-Weight Polyol and a Low-Molecular-Weight Polyol.

The high-molecular-weight polyol component is a polyol having a number-average molecular weight of 500 or more (for example, preferably 500 or more and 5,000 or less). Examples of the high-molecular-weight polyol component include known polyols such as a polyester polyol obtained by dehydration condensation of a low-molecular-weight polyol and a dibasic acid, a polycarbonate polyol obtained by a reaction between a low-molecular-weight polyol and an alkyl carbonate, a polycaprolactone polyol, and a polyether polyol. Examples of a commercially available product of the high-molecular-weight polyol include PLACCEL 205 and PLACCEL 240 manufactured by Daicel Corporation.

Here, the number-average molecular weight is a value measured by a gel permeation chromatography (GPC) method. The same applies hereinafter.

These high-molecular-weight polyols may be used alone or in combination of two or more kinds thereof.

A polymerization ratio of the high-molecular-weight polyol component may be, for example, 30 mol % or more and 50 mol % or less, and preferably 40 mol % or more and 50 mol % or less with respect to the total polymerization component of the polyurethane rubber.

The low-molecular-weight polyol component is a polyol having a molecular weight (number-average molecular weight) of less than 500. The low-molecular-weight polyol is a material that functions as a chain extender and a crosslinking agent.

Examples of the low-molecular-weight polyol component include 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among the above, for example, it is preferable that the low-molecular-weight polyol component includes at least one of 1,10-decanediol or 1,4-butanediol.

Examples of the low-molecular-weight polyol component include a diol (bifunctional), a triol (trifunctional), and a tetraol (tetrafunctional), that are known as a chain extender and a crosslinking agent.

These polyols may be used alone or in combination of two or more kinds thereof.

A polymerization ratio of the low-molecular-weight polyol component may be, for example, more than 50 mol % and 75 mol % or less, and preferably 52 mol % or more and 75 mol % or less, more preferably 55 mol % or more and 75 mol % or less, and still more preferably 55 mol % or more and 60 mol % or less with respect to the total polymerization component of the polyurethane rubber.

In addition, for example, it is preferable to contain, as the low-molecular-weight polyol component, 1,4-butanediol with a proportion of more than 20 mol % and 75 mol % or less (for example, preferably 20 mol % or more and 60 mol % or less, more preferably 25 mol % or more and 50 mol % or less, and still more preferably 30 mol % or more and 50 mol % or less) with respect to all polyol components (high-molecular-weight polyol+low-molecular-weight polyol).

By setting the proportion of 1,4-butanediol to be within the above-described range, it is easy to suppress local abrasion. On the other hand, by setting the proportion of 1,4-butanediol to 75 mol % or less, occurrence of chipping is likely to be suppressed.

A proportion of 1,4-butanediol in all low-molecular-weight polyol components is 80 mol % or more, for example, preferably 90 mol % or more, and more preferably 100 mol %. That is, for example, using only 1,4-butanediol as the low-molecular-weight polyol component is most preferable.

### Polyisocyanate Component

Examples of the polyisocyanate component include 4,4′-diphenylmethane diisocyanate (MDI), 2,6-toluene diisocyanate (TDI), 1,6-hexane diisocyanate (HDI), 1,5-naphthalene diisocyanate (NDI), and 3,3′-dimethylbiphenyl-4,4′-diisocyanate (TODI).

As the polyisocyanate component, for example, 4,4′-diphenylmethane diisocyanate (MDI), 1,5-naphthalene diisocyanate (NDI), or hexamethylene diisocyanate (HDI) is more desirable.

These polyisocyanate components may be used alone or in combination of two or more kinds thereof.

A polymerization ratio of the polyisocyanate component may be, for example, 5 mol % or more and 25 mol % or less, and preferably 10 mol % or more and 20 mol % or less with respect to the total polymerization component of the polyurethane rubber.

Resin Having Functional Group Capable of Reacting with Isocyanate Group

As the resin having a functional group capable of reacting with an isocyanate group (hereinafter, referred to as “functional group-containing resin”), for example, a resin having flexibility is desirable, and an aliphatic resin having a linear structure is more desirable from the viewpoint of flexibility. Specific examples of the functional group-containing resin include an acrylic resin having two or more hydroxyl groups, a polybutadiene resin having two or more hydroxyl groups, and an epoxy resin having two or more epoxy groups.

Examples of a commercially available product of the acrylic resin having two or more hydroxyl groups include ACTFLOW (grades: UMB-2005B, UMB-2005P, UMB-2005, UME-2005, and the like) manufactured by Soken Chemical & Engineering Co., Ltd.

Examples of a commercially available product of the polybutadiene resin having two or more hydroxyl groups include R-45HT manufactured by Idemitsu Kosan Co., Ltd.

As the epoxy resin having two or more epoxy groups, for example, it is desirable to use an epoxy resin that is not hard and brittle just as the general epoxy resins of the related art and is more flexible and tougher than the epoxy resins of the related art. As the above-described epoxy resin, in view of molecular structure, for example, an epoxy resin that has a structure (flexible skeleton) capable of improving mobility of a main chain in a main chain structure thereof is suitable, and examples of the flexible skeleton include an alkylene skeleton, a cycloalkane skeleton, and a polyoxyalkylene skeleton. Among the above, for example, a polyoxyalkylene skeleton is particularly suitable.

In addition, in view of physical properties, compared to the epoxy resins of the related art, for example, an epoxy resin having a low viscosity relative to the molecular weight is suitable. Specifically, for example, it is desirable that a weight-average molecular weight is in a range of 900±100 and a viscosity at 25° C. is in a range of 15000±5000 mPa·s, more desirably in a range of 15000±3000 mPa·s. Examples of a commercially available product of the epoxy resin having the above-described characteristics include EPLICON EXA-4850-150 manufactured by DIC Corporation.

A polymerization ratio of the functional group-containing resin may be, for example, in a range that does not impair the effect of the cleaning blade according to the present exemplary embodiment.

### Method of Producing Polyurethane Rubber and Method of Molding Contact Member

In production of the polyurethane rubber, a general production method of polyurethane, such as a prepolymer method and a one-shot method, is used. From the viewpoint of obtaining polyurethane having excellent abrasion resistance and excellent chipping resistance, for excellent, a prepolymer method is suitable for the present exemplary embodiment, but the manufacturing method is not limited thereto. The contact member (or the cleaning blade having a single-layer structure) is produced by molding a composition for forming a cleaning blade, containing a prepolymer of polyurethane rubber or the like, into a sheet shape using, for example, centrifugal molding or extrusion molding and performing cutting processing or the like as necessary.

Examples of a catalyst used for producing the polyurethane rubber include an amine-based compound such as a tertiary amine, a quaternary ammonium salt, and an organometallic compound such as an organic tin compound.

Examples of the tertiary amine include trialkylamine such as triethylamine; tetraalkyl diamine such as N,N,N′,N′-tetramethyl-1,3-butanediamine; aminoalcohol such as dimethylethanolamine; esteramine such as ethoxylated amine, ethoxylated diamine, and bis(diethylethanolamine) adipate; a cyclohexylamine derivative such as triethylenediamine (TEDA) and N,N-dimethylcyclohexylamine; a morpholine derivative such as N-methylmorpholine and N-(2-hydroxypropyl)-dimethylmorpholine; and a piperazine derivative such as N,N′-diethyl-2-methylpiperazine and N,N′-bis-(2-hydroxypropyl)-2-methylpiperazine.

Examples of the quaternary ammonium salt include 2-hydroxypropyltrimethylammonium octylate, 1,5-diazabicyclo[4.3.0]nonene-5 (DBN) octylate, 1,8-diazabicyclo[5.4.0]undecene-7 (DBU)-octylate, DBU-oleate, DBU-p-toluenesulfonate, DBU-formate, and 2-hydroxypropyltrimethylammonium formate.

Examples of the organic tin compound include a dialkyltin compound such as dibutyltin dilaurate and dibutyltin di(2-ethylhexoate), stannous 2-ethylcaproate, and stannous oleate.

Among these catalysts, in view of hydrolysis resistance, triethylenediamine (TEDA) that is a tertiary ammonium salt is used, and in view of processability, a quaternary ammonium salt is used. Among the quaternary ammonium salts, 1,5-diazabicyclo[4.3.0]nonene-5 (DBN) octylate, 1,8-diazabicyclo[5.4.0]undecene-7 (DBU)-octylate, or DBU-formate, that has high reaction activity, is used.

A content of the catalyst is, for example, preferably in a range of 0.0005% by mass or more and 0.03% by mass or less and particularly preferably 0.001% by mass or more and 0.01% by mass or less of the entire polyurethane rubber constituting the contact member.

The catalysts may be used alone or in combination of two or more kinds thereof.

Impregnation Treatment with Isocyanate

For example, it is preferable that the contact member is subjected to an impregnation treatment with an isocyanate.

The impregnation treatment with an isocyanate may be carried out by dipping the contact member to be treated in a treatment liquid containing an isocyanate. The isocyanate in the treatment liquid is, for example, cured in a region where the contact member is impregnated with the treatment liquid. A hardness of the treated portion (that is, the region where the contact member is impregnated with the treatment liquid) by the impregnation treatment is increased, and thus the abrasion resistance is increased. In addition, the isocyanate in the treatment liquid may react with the contact member (specifically, the functional group of the contact member), and in this case, the hardness of the treated portion (that is, the region where the contact member is impregnated with the treatment liquid) by the impregnation treatment is further increased, the abrasion resistance is further increased, and the cleaning performance is further improved.

The treatment liquid used for the impregnation treatment contains at least an isocyanate and an organic solvent.

Examples of the isocyanate used in the treatment liquid include isocyanates such as tolylene diisocyanate (TDI), 4,4′-diphenylmethane diisocyanate (MDI), p-phenylene diisocyanate (PPDI), naphthylene diisocyanate (NDI), and 3,3′-dimethylbiphenyl-4,4′-diyldiisocyanate (TODI), multimers thereof, and modified products thereof.

In addition, as the treatment liquid, for example, a mixed solution of an isocyanate, a polyol, and an organic solvent, or a mixed solution of an isocyanate group-containing compound having an isocyanate group at a terminal, that is obtained by reacting an isocyanate with a polyol, that is, an isocyanate group-containing prepolymer and an organic solvent is preferably used.

Furthermore, as the treatment liquid, for example, a mixed solution of a bifunctional isocyanate, a trifunctional polyol, and an organic solvent, or a mixed solution of an isocyanate group-containing prepolymer obtained by reacting a bifunctional isocyanate with a trifunctional polyol and an organic solvent is more preferably used.

Here, in a case where the mixed solution of a bifunctional isocyanate, a trifunctional polyol, and an organic solvent is used, the bifunctional isocyanate reacts with the trifunctional polyol to form an isocyanate group-containing prepolymer having an isocyanate group at a terminal, and the treatment liquid is cured and reacts with the contact member in a case where the contact member is impregnated with the treatment liquid.

In this manner, the treated portion formed by reacting the bifunctional isocyanate with the trifunctional polyol to obtain an isocyanate group-containing prepolymer or by using a treatment liquid containing the isocyanate group-containing prepolymer has high hardness even in a case where the thickness thereof is small, and thus the abrasion resistance thereof increases.

The formulation of the treatment liquid is appropriately selected in consideration of wettability to the contact member, degree of dipping, and validity period of the treatment liquid.

Examples of the bifunctional isocyanate include 4,4′-diphenylmethane diisocyanate (MDI), p-phenylene diisocyanate (PPDI), isophorone diisocyanate (IPDI), 4,4′-dicyclohexylmethane diisocyanate (H-MDI), trimethylhexamethylene diisocyanate (TMHDI), tolylene diisocyanate (TDI), carbodiimide-modified MDI, polymethylene polyphenyl polyisocyanate (PMDI), 3,3′-dimethylbiphenyl-4,4′-diyldiisocyanate (TODI), naphthylene diisocyanate (NDI), xylene diisocyanate (XDI), lysine diisocyanate methyl ester (LDI), dimethyl diisocyanate, multimers thereof, and modified products thereof.

Among the bifunctional isocyanates, for example, a bifunctional isocyanate having a molecular weight of 200 or more and 300 or less is preferably used. Examples of the bifunctional isocyanate include 4,4′-diphenylmethane diisocyanate (MDI) and 3,3′-dimethylbiphenyl-4,4′-diyldiisocyanate (TODI).

Examples of the trifunctional polyol include a trifunctional aliphatic polyol such as glycerin, 1,2,4-butanetriol, trimethylolethane (TME), trimethylolpropane (TMP), and 1,2,6-hexanetriol, a polyether triol obtained by adding ethylene oxide, butylene oxide, or the like to a trifunctional aliphatic polyol, and a polyester triol obtained by adding a lactone or the like to a trifunctional aliphatic polyol.

Among the trifunctional polyols, for example, a trifunctional polyol having a molecular weight of 150 or less is preferably used. Examples of the trifunctional polyol include trimethylolpropane (TMP). By using the trifunctional polyol having a molecular weight of 150 or less, the reaction with an isocyanate is rapid and the hardness of the treated portion can be increased. In addition, in a case where the treatment liquid contains the trifunctional polyol, a trifunctional hydroxyl group reacts with the isocyanate group to obtain a treated portion having a three-dimensional structure and a high crosslinking density.

The organic solvent used in the treatment liquid is not particularly limited as long as the isocyanate and the polyol used as necessary are dissolved, but a solvent having no active hydrogen, that can react with the isocyanate, is preferably used. Examples thereof include methyl ethyl ketone (MEK), methyl isobutyl ketone (MIBK), tetrahydrofuran (THF), acetone, ethyl acetate, butyl acetate, toluene, and xylene. As a boiling point of the organic solvent decreases, the solubility of the organic solvent increases, the drying after impregnation can be rapidly carried out, and the treatment can be uniformly performed. The organic solvent is appropriately selected depending on a degree of swelling of the contact member, and for example, methyl ethyl ketone (MEK), acetone, or ethyl acetate is preferably used.

A contact angle of the cleaning blade with respect to the surface of the electrophotographic photoreceptor 7 is, for example, preferably 5° or more and 25° or less, and more preferably 5° or more and 20° or less.

In a case where the contact angle is 5° or more, the contact line pressure of the cleaning blade on the surface of the electrophotographic photoreceptor is likely to be applied with high uniformity, and the increase in rotational torque is further suppressed. In addition, a residual toner on the surface of the electrophotographic photoreceptor is further suppressed from being falling off, and thus the cleaning properties are further improved.

In a case where the contact angle is 25° or less, it is easy to suppress the excessive increase in contact line pressure of the cleaning blade with respect to the surface of the electrophotographic photoreceptor, and the abrasion resistance of the surface of the electrophotographic photoreceptor is more excellent even in the medium- to long-term use. In addition, curling of the cleaning blade is easily suppressed, and the cleaning properties are further improved.

The contact line pressure NF of the blade is calculated by the following expression.

$$NF = k \times d \qquad Expression$$

In the expression, k represents a spring constant unique to the cleaning blade, and d represents an amount of indentation of the cleaning blade with respect to the surface of the electrophotographic photoreceptor 7 (see FIG. 4).

The spring constant k unique to the cleaning blade is obtained by causing displacement of the cleaning blade and measuring the load with a load cell.

The amount of indentation d of the cleaning blade with respect to the surface of the electrophotographic photoreceptor 7 is obtained by calculating the amount of displacement of the surface of the electrophotographic photoreceptor 7 in a case where the cleaning blade fixed to a fixing tool is brought into contact with the surface of the electrophotographic photoreceptor 7.

The contact angle of the cleaning blade means an angle (acute angle θ) at which a virtual line along a non-bent portion of the blade and a tangent line at a point where the virtual line is in contact with the surface of the electrophotographic photoreceptor 7 intersect with each other in a state in which the cleaning blade is brought into contact with the surface of the electrophotographic photoreceptor 7 (refer to FIG. 4).

In FIG. 4, CB represents the cleaning blade, MC represents the outermost surface of the electrophotographic photoreceptor, FI represents the fixing tool, NF represents the contact line pressure of the cleaning blade, d represents the amount of indentation of the cleaning blade with respect to the surface of the electrophotographic photoreceptor 7, and θ represents the contact angle of the cleaning blade.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like.

Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

FIG. 3 is a view schematically showing a configuration of another example of the image forming apparatus according to the present exemplary embodiment.

An image forming apparatus 120 shown in FIG. 3 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

### Electrophotographic Photoreceptor

The photoreceptor according to the present exemplary embodiment includes a conductive substrate, a charge generation layer disposed on the conductive substrate, and a charge transport layer disposed on the charge generation layer. The photoreceptor according to the present exemplary embodiment may further include other layers (for example, an undercoat layer and an interlayer).

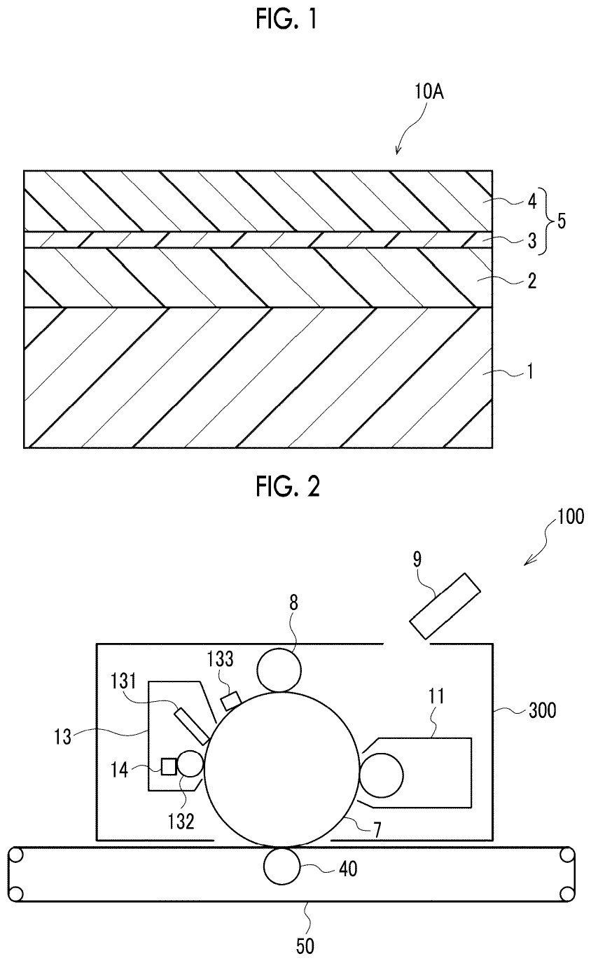

FIG. 1 is a partial cross-sectional view schematically showing an example of a layer configuration of the photoreceptor according to the present exemplary embodiment. A photoreceptor 10A shown in FIG. 1 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3.

### Charge Transport Layer

The charge transport layer is, for example, a layer containing a binder resin containing at least a polyarylate resin having a dicarboxylic acid unit represented by Formula (A) and a diol unit represented by Formula (B) and a polycarbonate resin, and containing a charge transport material.

Hereinafter, the polyarylate resin having the dicarboxylic acid unit represented by Formula (A) and the diol unit represented by Formula (B) is also referred to as “polyarylate resin (1)”. The charge transport layer may be a layer containing the polyarylate resin (1), a polycarbonate resin, and a polymer charge transport material.

### Polyarylate Resin (1)

The polyarylate resin (1) has at least the dicarboxylic acid unit (A) and the diol unit (B). The polyarylate resin (1) may have other dicarboxylic acid units in addition to the dicarboxylic acid unit (A). The polyarylate resin (1) may have other diol units in addition to the diol unit (B).

The dicarboxylic acid unit (A) is a constitutional unit represented by Formula (A).

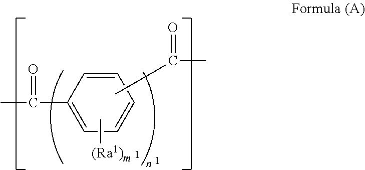

In Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms.

In Formula (A), n¹ is 1, 2, or 3, for example, preferably 2.

In a case where n¹ is 2, two benzene rings in Formula (A) may be benzene rings that are the same or different from each other with regard to m¹ and Ra¹.

In a case where n¹ is 3, three benzene rings in Formula (A) may be benzene rings that are the same or different from each other with regard to m¹ and Ra¹.

In a case where n¹ in Formula (A) is 2 or 3, a linking position between the benzene rings may be an ortho-position, a meta-position, or a para-position, and is, for example, preferably a meta-position or a para-position.

In Formula (A), m¹ is 0, 1, 2, 3 or 4, for example, preferably 0, 1, or 2, more preferably 0 or 1, and still more preferably 0.

In a case where m¹ is 2, two Ra¹'s bonded to the identical benzene ring may be groups that are the same or different from each other.

In a case where m¹ is 3, three Ra¹'s bonded to the identical benzene ring may be groups that are the same or different from each other.

In a case where m¹ is 4, four Ra¹'s bonded to the identical benzene ring may be groups that are the same or different from each other.

In Formula (A), the alkyl group having 1 or more and 10 or less carbon atoms may be linear, branched, or cyclic. The number of carbon atoms in the alkyl group is, for example, preferably 1 or more and 6 or less, more preferably 1 or more and 4 or less, and still more preferably 1 or 2.

In Formula (A), the aryl group having 6 or more and 12 or less carbon atoms may be monocyclic or polycyclic. The number of carbon atoms in the aryl group is, for example, preferably 6 or more and 10 or less, and more preferably 6 or more and 9 or less.

In Formula (A), an alkyl group of the alkoxy group having 1 or more and 6 or less carbon atoms may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

In Formula (A), examples of the linear alkyl group having 1 or more and 10 or less carbon atoms include a methyl group, an ethyl group, a n-propyl group, a n-butyl group, a n-pentyl group, a n-hexyl group, a n-heptyl group, a n-octyl group, a n-nonyl group, and a n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and a polycyclic (for example, bicyclic, tricyclic, or spirocyclic) alkyl group composed of these monocyclic alkyl groups linked to each other.

In Formula (A), examples of the aryl group having 6 or more and 12 or less carbon atoms include a phenyl group, a biphenyl group, a 1-naphthyl group, and a 2-naphthyl group.

In Formula (A), examples of the linear alkoxy group having 1 or more and 6 or less carbon atoms include a methoxy group, an ethoxy group, an n-propoxy group, an n-butoxy group, an n-pentyloxy group, and an n-hexyloxy group.

In Formula (A), examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

In Formula (A), examples of the cyclic alkoxy group having 3 or more and 6 or less carbon atoms include a cyclopropoxy group, a cyclobutoxy group, a cyclopentyloxy group, and a cyclohexyloxy group.

In Formula (A), in a case where m¹ is 1, 2, 3, or 4, Ra¹ is, for example, preferably a linear alkyl group having 1 or more and 6 or less carbon atoms or a branched alkyl group having 3 or more and 6 or less carbon atoms, more preferably a linear alkyl group having 1 or more and 4 or less carbon atoms or a branched alkyl group having 3 or 4 carbon atoms, and still more preferably a methyl group or an ethyl group.

Dicarboxylic acid units (A-1) to (A-13) are shown below as specific examples of the dicarboxylic acid unit (A). The dicarboxylic acid unit (A) is not limited thereto.

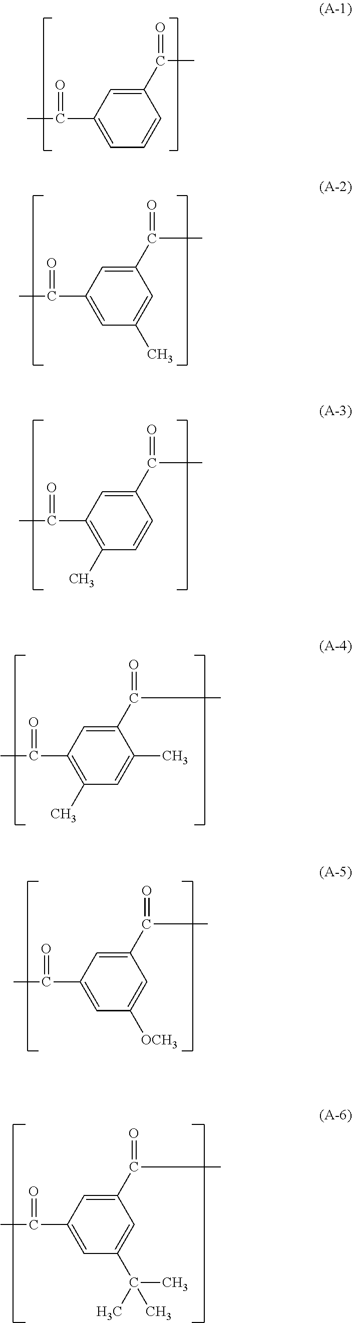

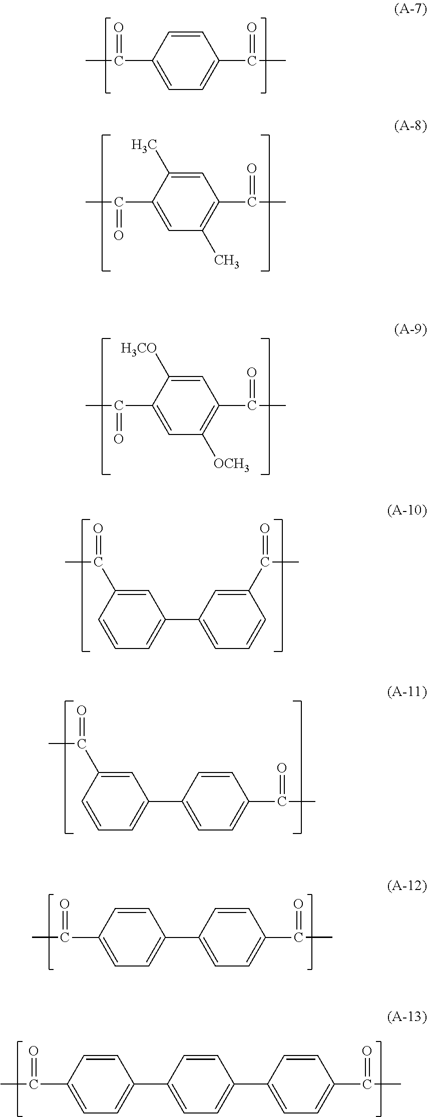

As the dicarboxylic acid unit (A), for example, (A-1), (A-7), or (A-12) in the above-described specific examples is preferable, and (A-12) is most preferable.

The dicarboxylic acid unit (A) included in the polyarylate resin (1) may be used alone or in combination of two or more kinds thereof.

The diol unit (B) is a constitutional unit represented by Formula (B).

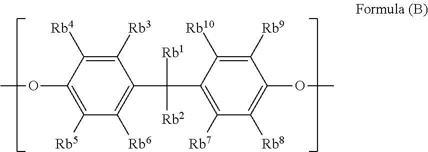

In Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

In Formula (B), the alkyl group having 1 or more and 20 or less carbon atoms, as Rb¹ and Rb², may be linear, branched, or cyclic. The number of carbon atoms in the alkyl group is, for example, preferably 1 or more and 15 or less, more preferably 1 or more and 12 or less, and still more preferably 1 or more and 10 or less.

In Formula (B), the aryl group having 6 or more and 12 or less carbon atoms, as Rb¹ and Rb², may be monocyclic or polycyclic. The number of carbon atoms in the aryl group is, for example, preferably 6 or more and 10 or less, and more preferably 6 or more and 9 or less.

In Formula (B), an aryl group of the aralkyl group having 7 or more and 20 or less carbon atoms, as Rb¹ and Rb², may be monocyclic or polycyclic, and an alkyl group of the aralkyl group having 7 or more and 20 or less carbon atoms may be linear, branched, or cyclic. The number of carbon atoms in the aryl group is, for example, preferably 6 or more and 10 or less, and more preferably 6 or more and 9 or less. The number of carbon atoms in the alkyl group is, for example, preferably 1 or more and 6 or less, more preferably 1 or more and 5 or less, and still more preferably 1 or more and 4 or less.

In Formula (B), the number of carbon atoms in the cyclic alkyl group that may be formed by Rb¹ and Rb² being bonded to each other is, for example, preferably 5 or more and 15 or less, and more preferably 6 or more and 12 or less.

In Formula (B), the alkyl group having 1 or more and 10 or less carbon atoms, as Rb³, Rb⁴, Rb⁵, Rb⁶, Rb⁷, Rb⁸, Rb⁹, and Rb¹⁰, may be linear, branched, or cyclic. The number of carbon atoms in the alkyl group is, for example, preferably 1 or more and 6 or less, more preferably 1 or more and 4 or less, and still more preferably 1 or 2.

In Formula (B), the aryl group having 6 or more and 12 or less carbon atoms, as Rb³, Rb⁴, Rb⁵, Rb⁶, Rb⁷, Rb⁸, Rb⁹, and Rb¹⁰, may be monocyclic or polycyclic. The number of carbon atoms in the aryl group is, for example, preferably 6 or more and 10 or less, and more preferably 6 or more and 9 or less.

In Formula (B), an aryl group of the aralkyl group having 7 or more and 20 or less carbon atoms, as Rb³, Rb⁴, Rb⁵, Rb⁶, Rb⁷, Rb⁸, Rb⁹, and Rb¹⁰, may be monocyclic or polycyclic, and an alkyl group of the aralkyl group having 7 or more and 20 or less carbon atoms may be linear, branched, or cyclic. The number of carbon atoms in the aryl group is, for example, preferably 6 or more and 10 or less, and more preferably 6 or more and 9 or less. The number of carbon atoms in the alkyl group is, for example, preferably 1 or more and 6 or less, more preferably 1 or more and 5 or less, and still more preferably 1 or more and 4 or less.

In Formula (B), an alkyl group of the alkoxy group having 1 or more and 6 or less carbon atoms, as Rb³, Rb⁴, Rb⁵, Rb⁶, Rb⁷, Rb⁸, Rb⁹, and Rb¹⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

In Formula (B), examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Specific examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and the like, and a polycyclic (for example, bicyclic, tricyclic, or spirocyclic) alkyl group composed of these monocyclic alkyl groups linked to each other.

In Formula (B), examples of the aryl group having 6 or more and 12 or less carbon atoms include a phenyl group, a biphenyl group, a 1-naphthyl group, and a 2-naphthyl group.

In Formula (B), examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

In Formula (B), examples of the linear alkoxy group having 1 or more and 6 or less carbon atoms include a methoxy group, an ethoxy group, an n-propoxy group, an n-butoxy group, an n-pentyloxy group, and an n-hexyloxy group.

In Formula (B), examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

In Formula (B), examples of the cyclic alkoxy group having 3 or more and 6 or less carbon atoms include a cyclopropoxy group, a cyclobutoxy group, a cyclopentyloxy group, and a cyclohexyloxy group.

In Formula (B), for example, it is preferable that Rb¹ and Rb² are each independently a hydrogen atom, a linear alkyl group having 1 or more and 12 or less carbon atoms, a branched alkyl group having 1 or more and 12 or less carbon atoms, an aryl group having 6 or more and 10 or less carbon atoms, or an aralkyl group having 7 or more and 10 or less carbon atoms, or Rb¹ and Rb² are bonded to each other to form a cyclic alkyl group having 5 or more and 12 or less carbon atoms.

In Formula (B), for example, it is more preferable that Rb¹ and Rb² are each independently a hydrogen atom, a linear alkyl group having 1 or more and 10 or less carbon atoms, or a branched alkyl group having 1 or more and 10 or less carbon atoms, or Rb¹ and Rb² are bonded to each other to form a cyclic alkyl group having 5 or more and 12 or less carbon atoms.

In Formula (B), for example, it is still more preferable that Rb¹ and Rb² are each independently a hydrogen atom, a linear alkyl group having 1 or more and 10 or less carbon atoms, or a branched alkyl group having 1 or more and 10 or less carbon atoms.

In Formula (B), for example, it is preferable that at least one of Rb¹ or Rb² is a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms, or Rb¹ and Rb² are bonded to each other to form a cyclic alkyl group having 5 or more and 12 or less carbon atoms.

In Formula (B), for example, it is more preferable that at least one of Rb¹ or Rb² is a linear alkyl group having 4 or more and 10 or less carbon atoms or a branched alkyl group having 4 or more and 10 or less carbon atoms.

In a case where at least one of Rb¹ or Rb² is as described above, for example, it is preferable that the other of Rb¹ or Rb² is a hydrogen atom or a linear alkyl group having 1 or more and 3 or less carbon atoms.

For example, it is preferable that the diol unit (B) is a constitutional unit represented by Formula (B′).

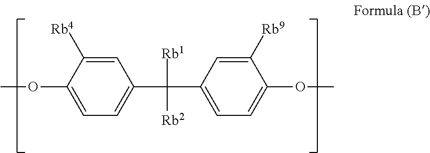

Rb¹, Rb², Rb⁴, and Rb⁹ in Formula (B′) each have the same definition as that for Rb¹, Rb², Rb⁴, and Rb⁹ in Formula (B), and aspects thereof are the same as described above.

As the diol unit (B), for example, in Formula (B′), an aspect in which Rb¹ is a hydrogen atom, a linear alkyl group having 1 or more and 3 or less carbon atoms, or a branched alkyl group having 3 carbon atoms, Rb² is a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms, and Rb⁴ and Rb⁹ are each independently a hydrogen atom or a methyl group is preferable; and an aspect in which Rb¹ is a hydrogen atom or a methyl group, Rb² is a linear alkyl group having 4 or more and 10 or less carbon atoms or a branched alkyl group having 4 or more and 10 or less carbon atoms, and Rb⁴ and Rb⁹ are each independently a hydrogen atom or a methyl group is more preferable.

Diol units (B-1) to (B-38) are shown below as specific examples of the diol unit (B). The diol unit (B) is not limited thereto.

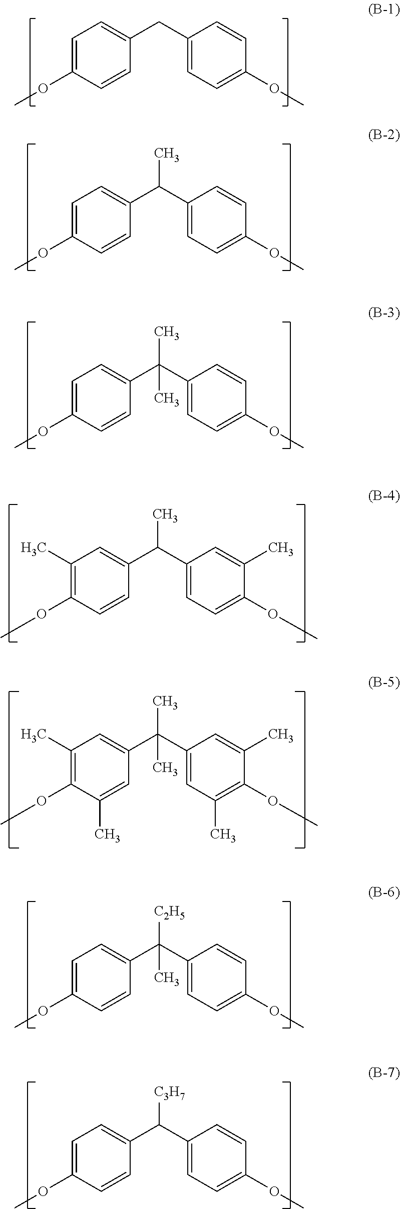

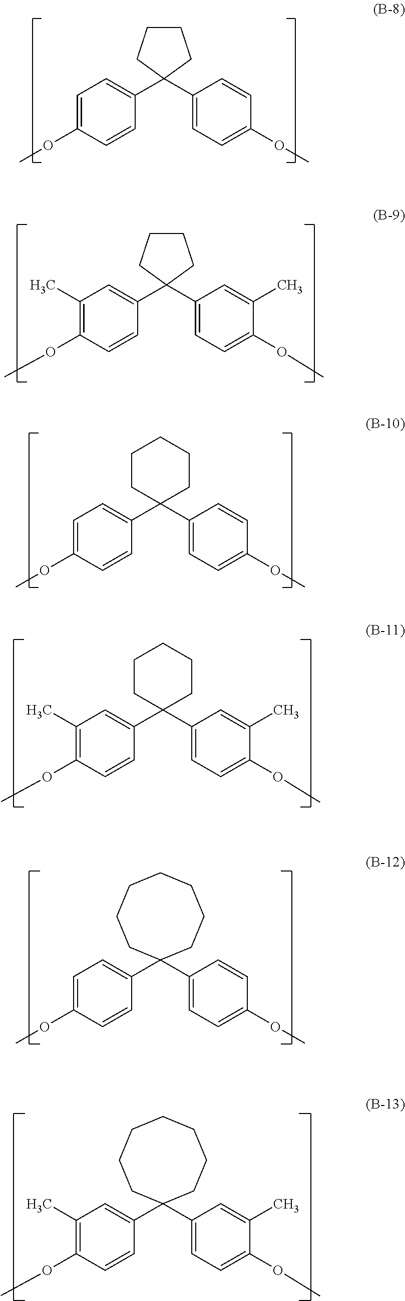

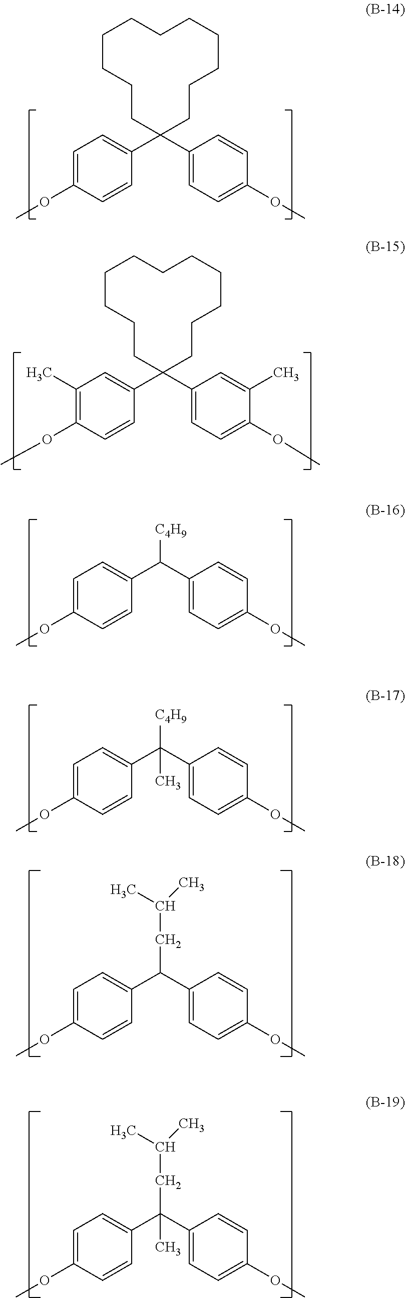

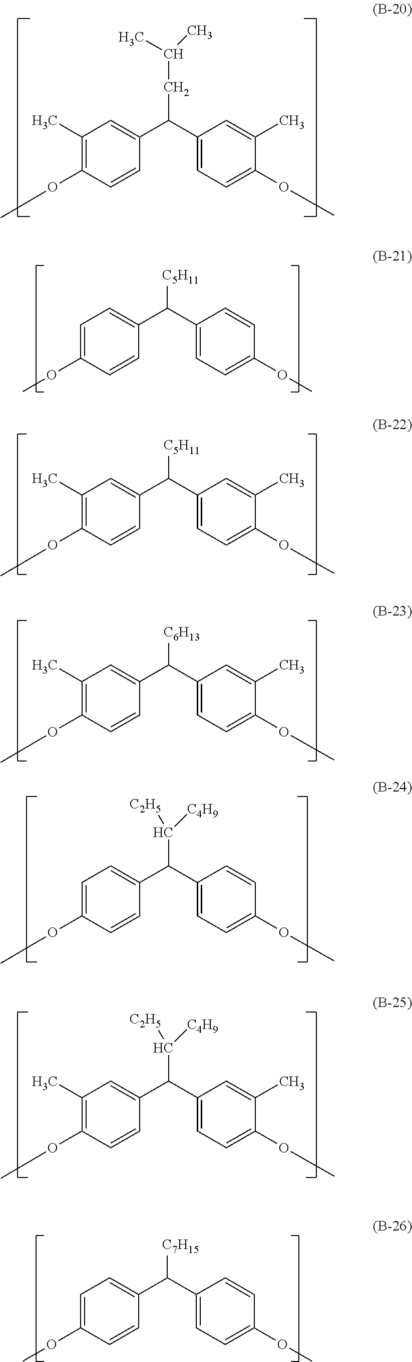

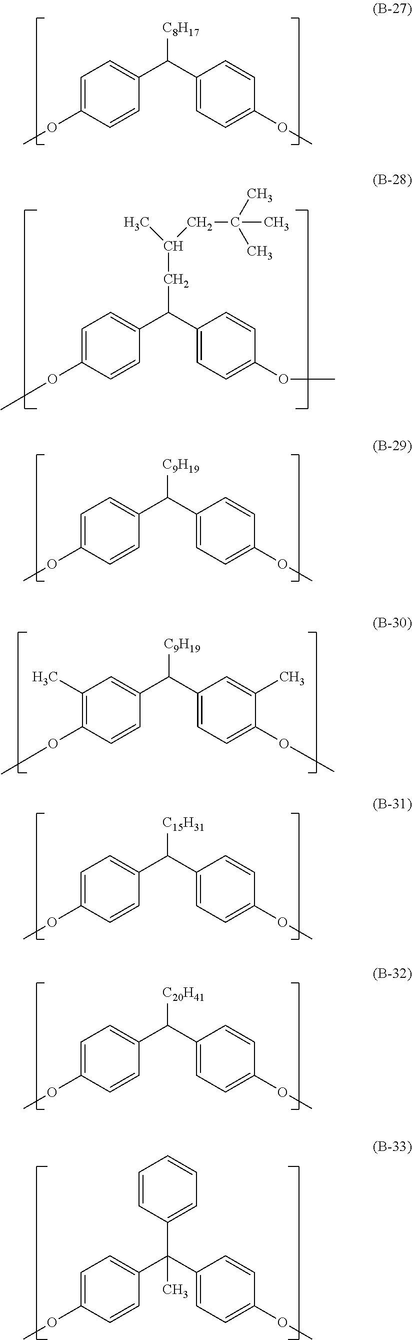

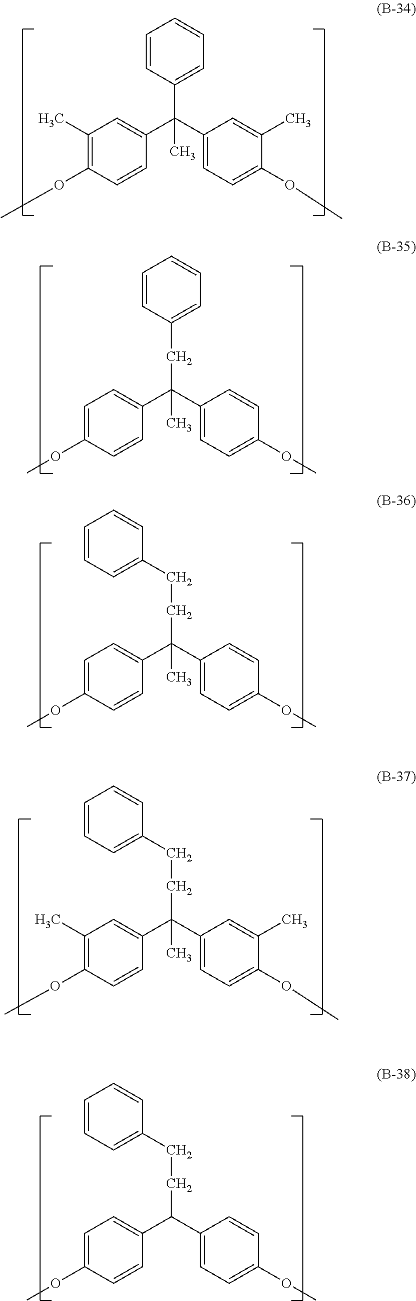

The diol unit (B) included in the polyarylate resin (1) may be used alone or in combination of two or more kinds thereof.

A mass proportion of the dicarboxylic acid unit (A) in the polyarylate resin (1) is, for example, preferably 15% by mass or more and 60% by mass or less.

In a case where the mass proportion of the dicarboxylic acid unit (A) is 15% by mass or more, the abrasion resistance of the photosensitive layer is enhanced. From the viewpoint, the mass proportion of the dicarboxylic acid unit (A) is, for example, more preferably 20% by mass or more, and still more preferably 25% by mass or more.

In a case where the mass proportion of the dicarboxylic acid unit (A) is 60% by mass or less, peeling of the photosensitive layer can be further suppressed. From the viewpoint, the mass proportion of the dicarboxylic acid unit (A) is, for example, more preferably 55% by mass or less, and still more preferably 50% by mass or less.

A mass proportion of the diol unit (B) in the polyarylate resin (1) is, for example, preferably 25% by mass or more and 60% by mass or less.

In a case where the mass proportion of the diol unit (B) is 25% by mass or more, peeling of the photosensitive layer can be further suppressed. From the viewpoint, the mass proportion of the diol unit (B) is, for example, more preferably 30% by mass or more, and still more preferably 35% by mass or more.

In a case where the mass proportion of the diol unit (B) is 60% by mass or less, solubility in a coating solution for forming the photosensitive layer is maintained, and thus the abrasion resistance can be improved. From the viewpoint, the mass proportion of the diol unit (B) is, for example, more preferably 55% by mass or less, and still more preferably 50% by mass or less.

The polyarylate resin (1) may have other dicarboxylic acid units in addition to the dicarboxylic acid unit (A).

Examples of the other dicarboxylic acid units include a dicarboxylic acid unit (C) represented by Formula (C).

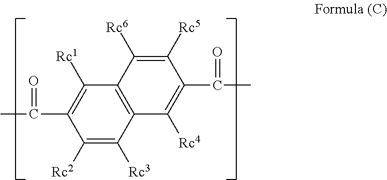

In Formula (C), Rc¹, Rc², Rc³, Rc⁴, Rc⁵, and Rc⁶ are each independently a hydrogen atom, an alkyl group having 1 or more and 10 or less carbon atoms, an aryl group having 6 or more and 12 or less carbon atoms, or an alkoxy group having 1 or more and 6 or less carbon atoms.

In Formula (C), the alkyl group having 1 or more and 10 or less carbon atoms may be linear, branched, or cyclic. The number of carbon atoms in the alkyl group is, for example, preferably 1 or more and 6 or less, more preferably 1 or more and 4 or less, and still more preferably 1 or 2.

In Formula (C), the aryl group having 6 or more and 12 or less carbon atoms may be monocyclic or polycyclic. The number of carbon atoms in the aryl group is, for example, preferably 6 or more and 10 or less, and more preferably 6 or more and 9 or less.

In Formula (C), an alkyl group of the alkoxy group having 1 or more and 6 or less carbon atoms may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, and the alkoxy group in Formula (C) include the same groups as the groups described in Formula (A) above.

In Formula (C), Rc¹, Rc², Rc³, Rc⁴, Rc⁵, and Rc⁶ are each independently, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom.

As the dicarboxylic acid unit (C), for example, a 2,6-naphthalenedicarboxylic acid unit (the following formula) is most preferable.

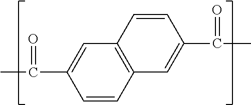

The dicarboxylic acid unit (C) included in the polyarylate resin (1) may be used alone or in combination of two or more kinds thereof.

In a case where the polyarylate resin (1) has the dicarboxylic acid unit (C), a mass proportion of the dicarboxylic acid unit (C) in the polyarylate resin (1) is, for example, preferably 1% by mass or more and 20% by mass or less.

Examples of the other dicarboxylic acid units include a dicarboxylic acid unit (D) represented by Formula (D).

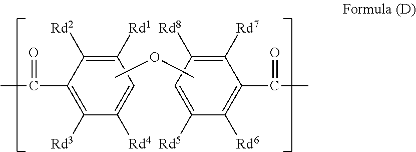

In Formula (D), Rd¹, Rd², Rd³, Rd⁴, Rd⁵, Rd⁶, Rd⁷, and Rd⁸ are each independently a hydrogen atom, an alkyl group having 1 or more and 10 or less carbon atoms, an aryl group having 6 or more and 12 or less carbon atoms, or an alkoxy group having 1 or more and 6 or less carbon atoms.

In Formula (D), the alkyl group having 1 or more and 10 or less carbon atoms may be linear, branched, or cyclic. The number of carbon atoms in the alkyl group is, for example, preferably 1 or more and 6 or less, more preferably 1 or more and 4 or less, and still more preferably 1 or 2.

In Formula (D), the aryl group having 6 or more and 12 or less carbon atoms may be monocyclic or polycyclic. The number of carbon atoms in the aryl group is, for example, preferably 6 or more and 10 or less, and more preferably 6 or more and 9 or less.

In Formula (D), an alkyl group of the alkoxy group having 1 or more and 6 or less carbon atoms may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, and the alkoxy group in Formula (D) include the same groups as the groups described in Formula (A) above.

In Formula (C), Rd¹, Rd², Rd³, Rd⁴, Rd⁵, Rd⁶, Rd⁷, and Rd⁸ are each independently, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom.

For example, it is preferable that the dicarboxylic acid unit (D) is a constitutional unit represented by Formula (D′).

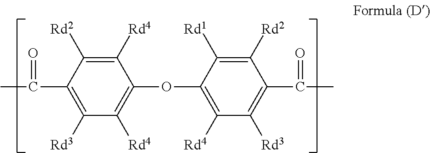

Rd¹, Rd², Rd³, and Rd⁴ in Formula (D′) each have the same definition as that for Rd¹, Rd², Rd³, and Rd⁴ in Formula (D), and aspects thereof are the same as described above.

As the dicarboxylic acid unit (D), for example, a diphenyl ether-4,4′-dicarboxylic acid unit (the following formula) is most preferable.

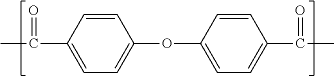

The dicarboxylic acid unit (D) included in the polyarylate resin (1) may be used alone or in combination of two or more kinds thereof.

In a case where the polyarylate resin (1) has the dicarboxylic acid unit (D), a mass proportion of the dicarboxylic acid unit (D) in the polyarylate resin (1) is, for example, preferably 1% by mass or more and 20% by mass or less.

Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower alkyl ester units (for example, having 1 or more and 5 or less carbon atoms) thereof. The dicarboxylic acid units included in the polyarylate resin (1) may be used alone or in combination of two or more kinds thereof.

The polyarylate resin (1) may have other diol units in addition to the diol unit (B). Examples of the other diol units include a diol unit (E) represented by Formula (E).

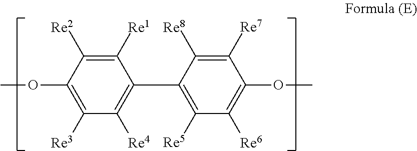

In Formula (E), Re¹, Re², Re³, Re⁴, Re⁵, Re⁶, Re⁷, and Re⁸ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In Formula (E), the alkyl group having 1 or more and 10 or less carbon atoms may be linear, branched, or cyclic. The number of carbon atoms in the alkyl group is, for example, preferably 1 or more and 6 or less, more preferably 1 or more and 4 or less, and still more preferably 1 or 2.

In Formula (E), the aryl group having 6 or more and 12 or less carbon atoms may be monocyclic or polycyclic. The number of carbon atoms in the aryl group is, for example, preferably 6 or more and 10 or less, and more preferably 6 or more and 9 or less.

In Formula (E), an aryl group of the aralkyl group having 7 or more and 20 or less carbon atoms may be monocyclic or polycyclic, and an alkyl group of the aralkyl group having 7 or more and 20 or less carbon atoms may be linear, branched, or cyclic. The number of carbon atoms in the aryl group is, for example, preferably 6 or more and 10 or less, and more preferably 6 or more and 9 or less. The number of carbon atoms in the alkyl group is, for example, preferably 1 or more and 6 or less, more preferably 1 or more and 5 or less, and still more preferably 1 or more and 4 or less.

In Formula (E), an alkyl group of the alkoxy group having 1 or more and 6 or less carbon atoms may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, the aralkyl group, and the alkoxy group in Formula (E) include the same groups as the groups described in Formula (B) above.

In Formula (E), Re¹, Re², Re³, Re⁴, Re⁵, Re⁶, Re⁷, and Re⁸ are each independently, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

For example, it is preferable that the diol unit (E) is a constitutional unit represented by Formula (E′).

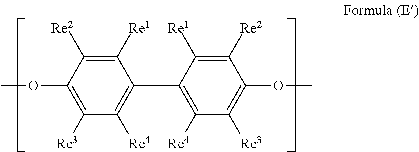

Re¹, Re², Re³, and Re⁴ in Formula (E′) each have the same definition as that for Re¹, Re², Re³, and Re⁴ in Formula (E), and aspects thereof are the same as described above.

As the diol unit (E), for example, any of the following units is most preferable.

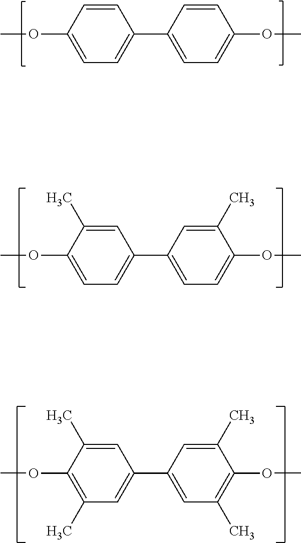

The diol unit (E) included in the polyarylate resin (1) may be used alone or in combination of two or more kinds thereof.

In a case where the polyarylate resin (1) has the diol unit (E), a mass proportion of the diol unit (E) in the polyarylate resin (1) is, for example, preferably 1% by mass or more and 20% by mass or less.

Examples of the other diol units include a diol unit (F) represented by Formula (F).

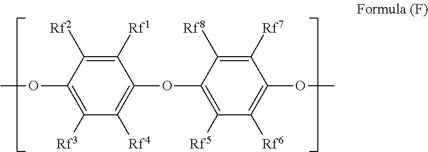

In Formula (F), Rf¹, Rf², Rf³, Rf⁴, Rf⁵, Rf⁶, Rf⁷, and Rf⁸ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In Formula (F), the alkyl group having 1 or more and 10 or less carbon atoms may be linear, branched, or cyclic. The number of carbon atoms in the alkyl group is, for example, preferably 1 or more and 6 or less, more preferably 1 or more and 4 or less, and still more preferably 1 or 2.

In Formula (F), the aryl group having 6 or more and 12 or less carbon atoms may be monocyclic or polycyclic. The number of carbon atoms in the aryl group is, for example, preferably 6 or more and 10 or less, and more preferably 6 or more and 9 or less.

In Formula (F), an aryl group of the aralkyl group having 7 or more and 20 or less carbon atoms may be monocyclic or polycyclic, and an alkyl group of the aralkyl group having 7 or more and 20 or less carbon atoms may be linear, branched, or cyclic. The number of carbon atoms in the aryl group is, for example, preferably 6 or more and 10 or less, and more preferably 6 or more and 9 or less. The number of carbon atoms in the alkyl group is, for example, preferably 1 or more and 6 or less, more preferably 1 or more and 5 or less, and still more preferably 1 or more and 4 or less.

In Formula (F), an alkyl group of the alkoxy group having 1 or more and 6 or less carbon atoms may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the respective aspects of the alkyl group, the aryl group, the aralkyl group, and the alkoxy group in Formula (F) include the same groups as the groups described in Formula (B) above.

In Formula (F), Rf¹, Rf², Rf³, Rf⁴, Rf⁵, Rf⁶, Rf⁷, and Rf⁸ are each independently, for example, preferably a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, still more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

For example, it is preferable that the diol unit (F) is a constitutional unit represented by Formula (F′).

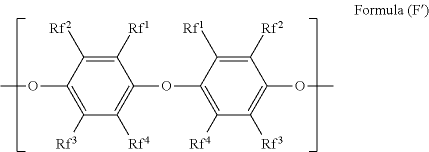

Rf¹, Rf², Rf³, and Rf⁴ in Formula (F′) each have the same definition as that for Rf¹, Rf², Rf³, and Rf⁴ in Formula (F), and aspects thereof are the same as described above.

As the diol unit (F), for example, a bis(4-hydroxyphenyl) ether unit (the following formula) is most preferable.

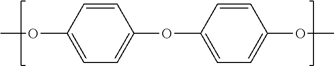

The diol unit (F) included in the polyarylate resin (1) may be used alone or in combination of two or more kinds thereof.

In a case where the polyarylate resin (1) has the diol unit (F), a mass proportion of the diol unit (F) in the polyarylate resin (1) is, for example, preferably 1% by mass or more and 20% by mass or less.

Examples of other diol units include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. The diol units included in the polyarylate resin (1) may be used alone or in combination of two or more kinds thereof.

The polyarylate resin (1) can be obtained by polycondensing a monomer providing the dicarboxylic acid unit (A), a monomer providing the diol unit (B), and other monomers as necessary using a method in the related art. Examples of the method of polycondensing the monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B. Since the interfacial polymerization method enables the reaction to proceed faster than the reaction carried out by the solution polymerization method and also enables suppression of hydrolysis of the divalent carboxylic acid halide, as a result, a high-molecular-weight polyester resin can be obtained.

A terminal of the polyarylate resin (1) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl) propane, 2-phenyl-2-(2-hydroxyphenyl) propane, and 2-phenyl-2-(3-hydroxyphenyl) propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

From the viewpoint of abrasion resistance of the charge transport layer, a weight-average molecular weight of the polyarylate resin (1) is, for example, preferably 50,000 or more, more preferably 60,000 or more, and still more preferably 70,000 or more.

From the viewpoint of coating properties of the charge transport layer and adhesiveness to the charge generation layer, the weight-average molecular weight of the polyarylate resin (1) is, for example, preferably 400,000 or less, preferably 300,000 or less, and more preferably 250,000 or less.

A method of measuring the weight-average molecular weight of the polyarylate resin (1) contained in the charge transport layer is as follows. The photoreceptor is dipped in various solvents (mixed solvents may be used), and the solvent in which the charge transport layer is dissolved is grasped. The photoreceptor is dipped in a solvent in which the charge transport layer is dissolved to extract the charge transport layer. The solution from which the charge transport layer has been extracted is dropped into a poor solvent for the polyarylate resin (1) (for example, a non-polar solvent such as hexane and toluene, or a lower alcohol such as methanol and isopropanol; the poor solvent may be a mixed solvent) to re-precipitate the resin. As necessary, the re-precipitation treatment is repeated twice, and the re-precipitate is vacuum-dried to obtain the polyarylate resin (1). The polyarylate resin (1) is subjected to molecular weight measurement by gel permeation chromatography (GPC) to specify the weight-average molecular weight. Tetrahydrofuran is used as an eluent of GPC, and polystyrene is used as a standard sample.

### Polycarbonate Resin

As the polycarbonate resin, a known polycarbonate resin is used. Suitable examples of the polycarbonate resin include a polycarbonate resin (hereinafter, also referred to as “BP polycarbonate resin”) including a constitutional unit having at least one of a biphenyl skeleton or a bisphenol skeleton.

Examples of the BP polycarbonate resin include a homopolymer composed of a constitutional unit having a biphenyl skeleton, a homopolymer composed of a constitutional unit having a bisphenol skeleton, and a copolymer composed of at least one of a constitutional unit having a biphenyl skeleton or a constitutional unit having a bisphenol skeleton. Among the above, from the viewpoint of abrasion resistance, the BP polycarbonate resin is, for example, preferably a homopolymer composed of a constitutional unit having a biphenyl skeleton.

Examples of the bisphenol skeleton include a bisphenol A skeleton, a bisphenol B skeleton, a bisphenol BP skeleton, a bisphenol C skeleton, a bisphenol F skeleton, and a bisphenol Z skeleton.

Specific examples of the BP polycarbonate resin include a homopolymer of a dihydroxybiphenyl compound, a homopolymer of a dihydroxybisphenol compound, and a copolymer thereof. These polymers can be obtained, for example, by a method such as polycondensation with a carbonate ester-forming compound such as phosgene and a transesterification reaction with bisaryl carbonate using the above-described compounds as a raw material.

The dihydroxybiphenyl compound is a biphenyl compound having a biphenyl skeleton, in which two benzene rings of the biphenyl skeleton each have one hydroxyl group. Examples of the dihydroxybiphenyl compound include 4,4′-dihydroxybiphenyl, 4,4′-dihydroxy-3,3′-dimethylbiphenyl, 4,4′-dihydroxy-2,2′-dimethylbiphenyl, 4,4′-dihydroxy-3,3′-dicyclohexylbiphenyl, 3,3′-difluoro-4,4′-dihydroxybiphenyl, and 4,4′-dihydroxy-3,3′-diphenylbiphenyl.

These dihydroxybiphenyl compounds may be used alone or in combination of a plurality of kinds thereof.

The dihydroxybisphenol compound is a bisphenol compound having a bisphenol skeleton, in which two benzene rings of the bisphenol skeleton each have one hydroxyl group. Examples of the dihydroxybisphenol compound include bis(4-hydroxyphenyl) methane, 1,1-bis(4-hydroxyphenyl) ethane, 1,2-bis(4-hydroxyphenyl) ethane, 2,2-bis(4-hydroxyphenyl) propane, 2,2-bis(3-methyl-4-hydroxyphenyl) butane, 2,2-bis(4-hydroxyphenyl) butane, 2,2-bis(4-hydroxyphenyl) octane, 4,4-bis(4-hydroxyphenyl) heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl) ether, bis(4-hydroxyphenyl) sulfide, bis(4-hydroxyphenyl) sulfone, 1,1-bis(4-hydroxyphenyl)cyclopentane, 1,1-bis(4-hydroxyphenyl)cyclohexane, 2,2-bis(3-methyl-4-hydroxyphenyl) propane, 2-(3-methyl-4-hydroxyphenyl)-2-(4-hydroxyphenyl)-1-phenylethane, bis(3-methyl-4-hydroxyphenyl) sulfide, bis(3-methyl-4-hydroxyphenyl) sulfone, bis(3-methyl-4-hydroxyphenyl) methane, 1,1-bis(3-methyl-4-hydroxyphenyl)cyclohexane, 2,2-bis(2-methyl-4-hydroxyphenyl) propane, 1,1-bis(2-butyl-4-hydroxy-5)-methylphenyl) butane, 1,1-bis(2-tert-butyl-4-hydroxy-3-methylphenyl) ethane, 1,1-bis(2-tert-butyl-4-hydroxy-5-methylphenyl) propane, 1,1-bis(2-tert-butyl-4-hydroxy-5-methylphenyl) butane, 1,1-bis(2-tert-butyl-4-hydroxy-5-methylphenyl) isobutane, 1,1-bis(2-tert-butyl-4-hydroxy-5-methylphenyl) heptane, 1,1-bis(2-tert-butyl-4-hydroxy-5-methylphenyl)-1-phenylmethane, 1,1-bis(2-tert-amyl-4-hydroxy-5-methylphenyl) butane, bis(3-chloro-4-hydroxyphenyl) methane, bis(3,5-dibromo-4-hydroxyphenyl) methane, 2,2-bis(3-chloro-4-hydroxyphenyl) propane, 2,2-bis(3-fluoro-4-hydroxyphenyl) propane, 2,2-bis(3-bromo-4-hydroxyphenyl) propane, 2,2-bis(3,5-difluoro-4-hydroxyphenyl) propane, 2,2-bis(3,5-dichloro-4-hydroxyphenyl) propane, 2,2-bis(3,5-dibromo-4-hydroxyphenyl) propane, 2,2-bis(3-bromo-4-hydroxy-5-chlorophenyl) propane, 2,2-bis(3,5-dichloro-4-hydroxyphenyl) butane, 2,2-bis(3,5-dibromo-4-hydroxyphenyl) butane, 1-phenyl-1,1-bis(3-fluoro-4-hydroxyphenyl) ethane, bis(3-fluoro-4-hydroxyphenyl) ether, and 1,1-bis(3-cyclohexyl-4-hydroxyphenyl)cyclohexane.

These bisphenol compounds may be used alone or in combination of a plurality of kinds thereof.

Among the above, from the viewpoint of abrasion resistance, the BP polycarbonate resin is preferably a polycarbonate resin including at least one of a constitutional unit represented by Formula (PCA) or a constitutional unit represented by Formula (PCB). That is, examples of the BP polycarbonate resin include a homopolymer composed of a constitutional unit represented by Formula (PCA), a homopolymer composed of a constitutional unit represented by Formula (PCB), and a copolymer thereof.

Among the above, from the viewpoint of abrasion resistance, for example, a polycarbonate resin including a constitutional unit represented by Formula (PCA) is more preferable.

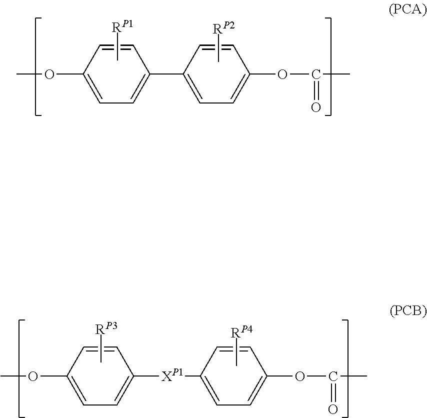

In Formulae (PCA) and (PCB), R^{P1}, R^{P2}, R^{P3}, and R^{P4} are each independently a hydrogen atom, a halogen atom, an alkyl group having 1 or more and 6 or less carbon atoms, a cycloalkyl group having 5 or more and 7 or less carbon atoms, or an aryl group having 6 or more and 12 or less carbon atoms. X^{P1} is a phenylene group, a biphenylylene group, a naphthylene group, an alkylene group, or a cycloalkylene group.

Examples of the alkyl group represented by R^{P1}, R^{P2}, R^{P3}, and R^{P4} in Formulae (PCA) and (PCB) include a linear or branched alkyl group having 1 or more and 6 or less carbon atoms (for example, preferably 1 or more and 3 or less carbon atoms).

Specific examples of the linear alkyl group include a methyl group, an ethyl group, an n-propyl group, an n-butyl group, an n-pentyl group, and an n-hexyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, and a tert-hexyl group.

Among the above, for example, a lower alkyl group such as a methyl group and an ethyl group is preferable as the alkyl group.

Examples of the cycloalkyl group represented by R^{P1}, R^{P2}, R^{P3}, and R^{P4} in Formulae (PCA) and (PCB) include cyclopentyl, cyclohexyl, and cycloheptyl.

Examples of the aryl group represented by R^{P1}, R^{P2}, R^{P3}, and R^{P4} in Formulae (PCA) and (PCB) include a phenyl group, a naphthyl group, and a biphenylyl group.

Examples of the alkylene group represented by X^{P1} in Formulae (PCA) and (PCB) include a linear or branched alkylene group having 1 or more and 12 or less carbon atoms (for example, preferably 1 or more and 6 or less carbon atoms and more preferably 1 or more and 3 or less carbon atoms).

Specific examples of the linear alkylene group include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, and an n-dodecylene group.

Specific examples of the branched alkylene group include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isoundecylene group, a sec-undecylene group, a tert-undecylene group, a neoundecylene group, an isododecylene group, a sec-dodecylene group, a tert-dodecylene group, and a neododecylene group.

Among the above, preferred examples of the alkylene group include a lower alkyl group such as a methylene group, an ethylene group, and a butylene group.

Examples of the cycloalkylene group represented by X^{P1} in Formulae (PCA) and (PCB) include a cycloalkylene group having 3 or more and 12 or less carbon atoms (for example, preferably 3 or more and 10 or less carbon atoms and more preferably 5 or more and 8 or less carbon atoms).

Specific examples of the cycloalkylene group include a cyclopropylene group, a cyclopentylene group, a cyclohexylene group, a cyclooctylene group, and a cyclododecanylene group.

Among the above, for example, a cyclohexylene group is preferable as the cycloalkylene group.

Each of the above-described substituents represented by R^{P1}, R^{P2}, R^{P3}, R^{P4}, or X^{P1} in Formulae (PCA) and (PCB) includes a group further having a substituent. Examples of the substituent include a halogen atom (such as a fluorine atom and a chlorine atom), an alkyl group (such as an alkyl group having 1 or more and 6 or less carbon atoms), a cycloalkyl group (such as a cycloalkyl group having 5 or more and 7 or less carbon atoms), an alkoxy group (such as an alkoxy group having 1 or more and 4 or less carbon atoms), and an aryl group (such as a phenyl group, a naphthyl group, and a biphenylyl group).

In Formula (PCA), R^{P1} and R^{P2} each independently represent, for example, preferably a hydrogen atom or an alkyl group having 1 or more and 6 or less carbon atoms, and more preferably a hydrogen atom.

In Formula (PCB), for example, it is preferable that R^{P3} and R^{P4} each independently represent a hydrogen atom or an alkyl group having 1 or more and 6 or less carbon atoms and X^{P1} represents an alkylene group or a cycloalkylene group.

Specific examples of the BP polycarbonate resin include the following resins, but the BP polycarbonate resin not limited thereto. In the exemplary compounds, pm and pn represent a copolymerization ratio.

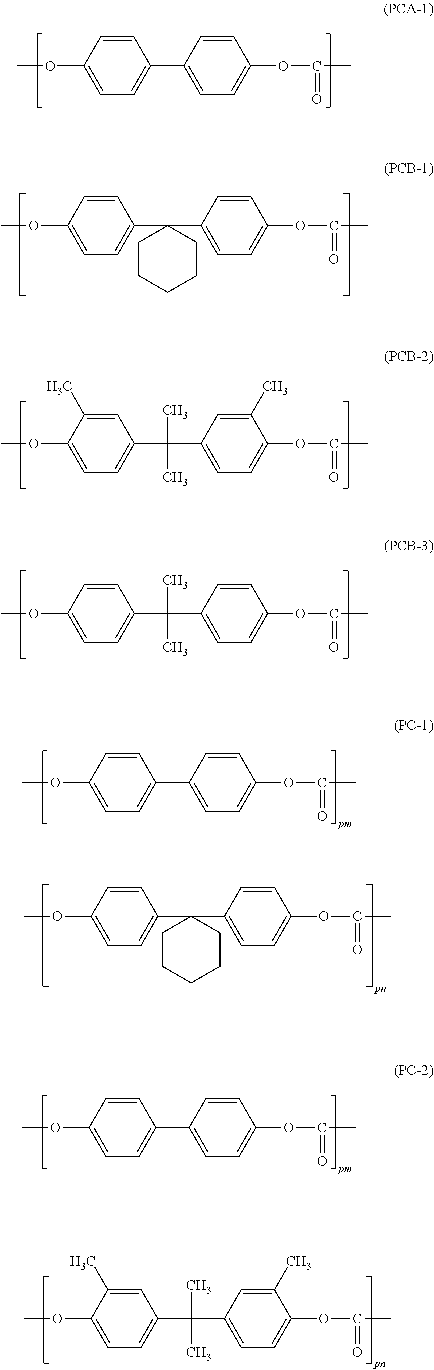

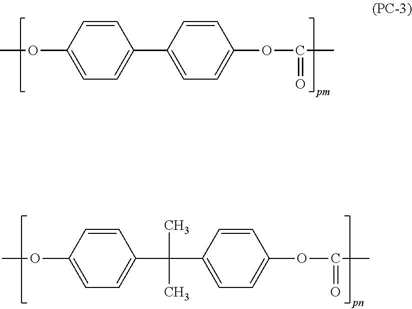

Here, in the polycarbonate resin, from the viewpoint of abrasion resistance, a content (copolymerization ratio) of the constitutional unit represented by Formula (PCA) is, for example, preferably in a range of 5 mol % or more and 95 mol % or less, more preferably in a range of 5 mol % or more and 50 mol % or less, and still more preferably in a range of 15 mol % or more and 30 mol % or less with respect to all constitutional units constituting the polycarbonate resin.

Specifically, in the above-described exemplary compounds of the polycarbonate resin, pm and pn represent a copolymerization ratio (molar ratio); and pm:pn is, for example, preferably in a range of 95:5 to 5:95, more preferably in a range of 50:50 to 5:95, and still more preferably 15:85 to 30:70.

The charge transport layer contains at least the polyarylate resin (1) and the polycarbonate resin as a binder resin. A proportion of the total amount of the polyarylate resin (1) and the polycarbonate resin with respect to the total amount of the binder resin contained in the charge transport layer is, for example, preferably 50% by mass or more, more preferably 80% by mass or more, still more preferably 90% by mass or more, particularly preferably 95% by mass or more, and most preferably 100% by mass.

A content of the polyarylate resin with respect to the charge transport layer is, for example, preferably 18% by mass or more and 54% by mass or less, more preferably 25% by mass or more and 48% by mass or less, and still more preferably 25% by mass or more and 45% by mass or less.

In a case where the content of the polyarylate resin is 18% by mass or more, for example, a sea-island structure in which the polyarylate resin having high hardness and the polycarbonate resin having high sliding properties are included is suitably formed in the charge generation layer. Therefore, the contact pressure of the cleaning blade with respect to the surface of the photoreceptor is appropriately dispersed and stabilized, the abrasion resistance is excellent even in the medium- to long-term use, and the increase in rotational torque is suppressed.

In a case where the content of the polyarylate resin is 54% by mass or less, a decrease in sliding properties of the layer surface due to a relatively decrease in proportion of the polycarbonate resin is suppressed, or an excessive increase in hardness due to the polyarylate resin is suppressed. As a result, the increase in rotational torque is further suppressed.

A content of the polycarbonate resin with respect to the charge transport layer is, for example, preferably 6% by mass or more, more preferably 10% by mass or more and 55% by mass or less, still more preferably 12% by mass or more and 48% by mass or less, and particularly preferably 14% by mass or more and 32% by mass or less.

In a case where the content of the polycarbonate resin is 5% by mass or more, for example, a sea-island structure in which the polyarylate resin having high hardness and the polycarbonate resin having high sliding properties are included is suitably formed in the charge generation layer. Therefore, the contact pressure of the cleaning blade with respect to the surface of the photoreceptor is appropriately dispersed and stabilized, the abrasion resistance is excellent even in the medium- to long-term use, and the increase in rotational torque is suppressed.

In a case where the content of the polycarbonate resin is 55% by mass or less, a decrease in hardness of the layer surface due to a relatively decrease in proportion of the polyarylate resin is suppressed, or an excessive increase in sliding properties due to the polycarbonate resin is suppressed. As a result, the increase in rotational torque is further suppressed.

A mass ratio (polyarylate resin/polycarbonate resin) of the polyarylate resin to the polycarbonate resin is, for example, preferably 3/8 or more and 10/1 or less, more preferably 4/5 or more and 9/1 or less, and still more preferably 4/5 or more and 8/2 or less.

In a case where the mass ratio (polyarylate resin/polycarbonate resin) is 3/8 or more, for example, a sea-island structure in which the polyarylate resin having high hardness and the polycarbonate resin having high sliding properties are included is suitably formed in the charge generation layer. Therefore, the contact pressure of the cleaning blade with respect to the surface of the photoreceptor is appropriately dispersed and stabilized, the abrasion resistance is excellent even in the medium- to long-term use, and the increase in rotational torque is suppressed.

In a case where the content of the mass ratio (polyarylate resin/polycarbonate resin) is 10/1 or less, a decrease in hardness of the layer surface due to a relatively decrease in proportion of the polyarylate resin is suppressed, or an excessive increase in sliding properties due to the polycarbonate resin is suppressed. As a result, the increase in rotational torque is further suppressed.

The charge transport layer may contain other binder resins in addition to the polyarylate resin (1) and the polycarbonate resin. Examples of other binder resins include a polyester resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. The binder resins may be used alone or in combination of two or more kinds thereof.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

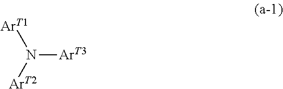

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

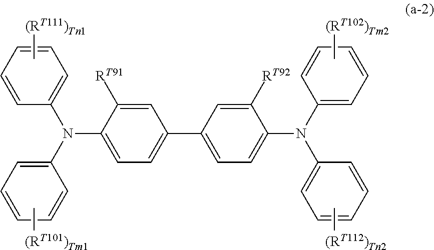

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, polyester-based polymer charge transport materials described in JP1996-176293A, JP1996-208820A, and the like are particularly preferable. The polymer charge transport material may be used alone or in combination of the binder resin.

Examples of the charge transport material or the polymer charge transport material include a polycyclic aromatic compound, a heterocyclic compound, a hydrazone compound, a styryl compound, an enamine compound, a benzidine compound, a triarylamine compound, a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, and a resin having a group derived from any of these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, and paragraph 0116 of JP2013-097300A.

A content of the charge transport material contained in the charge transport layer may be, for example, 28% by mass or more and 55% by mass or less with respect to the total solid content.

The charge transport layer may also contain other known additives. Examples of the additive include an antioxidant, a leveling agent, an antifoaming agent, a filler, and a viscosity adjuster.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

An average thickness of the charge transport layer is, for example, preferably 27 μm or more and 50 μm or less, more preferably 31 μm or more and 48 μm or less, and still more preferably 35 μm or more and 46 μm or less.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; and a diphenoquinone compound such as 3,3′,5,5′-tetra-t-butyldiphenoquinone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while agitating the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing agitating or using ultrasonic waves, a sand mill, an attritor, or a ball mill, agitating or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while agitating and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to 1/2 from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A thickness of the undercoat layer is set to, for example, preferably 15 μm or more and more preferably in a range of 20 μm or more and 50 μm or less.

### Interlayer

An interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method (a coating method for forming an interlayer of FB photoreceptor).

A thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as an agitator, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A thickness of the charge generation layer is set to, for example, preferably in a range of 0.1 μm or more and 5.0 μm or less and more preferably in a range of 0.2 μm or more and 2.0 μm or less.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at room temperature (25° C.±3° C.), unless otherwise specified.

### Preparation of Polyarylate Resin (1)

### Polyarylate Resin (1-1)

12.6373 g of 4,4′-(2-ethylhexylidene)diphenol, 0.1233 g of 4-tert-butylphenol, 0.0632 g of sodium hydrosulfite, and 240 mL of water are added to a reaction container equipped with a stirrer to obtain a suspension. 4.8392 g of sodium hydroxide, 0.1981 g of benzyltributylammonium chloride, and 160 mL of water are added to the suspension while being stirred at a temperature of 20° C., and the mixture is stirred for 30 minutes in a nitrogen atmosphere. 220 mL of o-dichlorobenzene is added to the aqueous solution, the solution is stirred for 30 minutes in a nitrogen atmosphere, and 12.0000 g of 4,4′-biphenyldicarbonyl chloride in a state of powder is added thereto. After completion of the addition, the reaction is allowed to proceed by stirring the solution at a temperature of 20° C. for 4 hours in a nitrogen atmosphere. The polymerized solution is diluted with 300 mL of o-dichlorobenzene to remove the aqueous layer. After the solution is washed with a dilute acetic acid solution and ion exchange water, the solution is poured into methanol to precipitate the polymer. The precipitated polymer is separated by filtration and dried at 50° C. The polymer is re-dissolved in 900 mL of tetrahydrofuran, and the mixture is poured into methanol to precipitate the polymer. The precipitated polymer is separated by filtration, washed with methanol, and dried at 50° C., thereby obtaining 17.5 g of a white polymer.

A molecular weight is measured by gel permeation chromatography (GPC) using tetrahydrofuran as an eluent, and the molecular weight of the polymer is determined as a molecular weight in terms of polystyrene. A weight-average molecular weight of the polymer is 100,000.

A chemical structure of the polyarylate resin (1-1) is shown below. The numerical value in the structural formula of the following polyarylate resin (1-1) is a molar ratio.

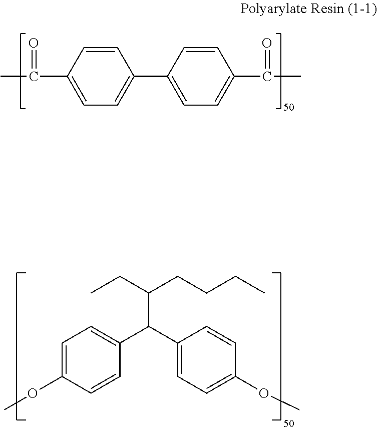

### Example 1

### Production of Electrophotographic Photoreceptor

### Formation of Undercoat Layer

An aluminum cylindrical tube having an outer diameter of 30 mm, a length of 365 mm, and a thickness of 1 mm is prepared as a conductive substrate.

100 parts of zinc oxide (average particle size: 70 nm, specific surface area: 15 m²/g, manufactured by Tayca Corporation) is stirred and mixed with 500 parts of toluene, 1.3 parts of a silane coupling agent (trade name: KBM603, manufactured by Shin-Etsu Chemical Co., Ltd., N-2-(aminoethyl)-3-aminopropyltrimethoxysilane) is added thereto, and the mixture is stirred for 2 hours. Next, the toluene is distilled off under reduced pressure and baked at 120° C. for 3 hours to obtain zinc oxide subjected to a surface treatment with the silane coupling agent.

110 parts of the surface-treated zinc oxide is stirred and mixed with 500 parts of tetrahydrofuran, a solution obtained by dissolving 0.6 parts of alizarin in 50 parts of tetrahydrofuran is added thereto, and the mixture is stirred at 50° C. for 5 hours. Next, the solid content is separated by filtration by carrying out filtration under reduced pressure, and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, manufactured by Sumitomo Bayer Urethane Co., Ltd.), and 15 parts of a butyral resin (trade name: S-LEC BM-1, manufactured by Sekisui Chemical Co., Ltd.) in 68 parts of methyl ethyl ketone is mixed with 5 parts of methyl ethyl ketone, and the mixture is dispersed in a sand mill for 2 hours using glass beads with a diameter of 1 mmφ, thereby obtaining a dispersion liquid. 0.005 parts of dioctyl tin dilaurate as a catalyst and 4 parts of silicone resin particles (trade name: TOSPEARL 145, manufactured by Momentive Performance Materials Inc.) are added to the dispersion liquid to obtain a coating solution for forming an undercoat layer. The outer peripheral surface of the conductive substrate is coated with the coating solution for forming an undercoat layer by a dip coating method, and dried and cured at 170° C. for 40 minutes to form an undercoat layer with an average thickness of 25 μm.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, manufactured by Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped in and coated with the coating solution for forming a charge generation layer, and dried at room temperature (25° C.±3° C.) to form a charge generation layer having an average thickness of 0.18 μm.

### Formation of Charge Transport Layer

30 parts by mass of the polyarylate resin (1-1) as a binder resin, 30 parts by mass of a polycarbonate resin (1-1) having the following structural formula (the numerical value in the structural formula is a molar ratio), and 70 parts of CTM (4) having the following structural formula as a charge transport material are dissolved in 135 parts of tetrahydrofuran and 15 parts of toluene to obtain a coating solution for forming a charge transport layer. The charge generation layer is dipped and coated with the coating solution for forming a charge transport layer, and dried at 145° C. for 30 minutes to form a charge transport layer having an average thickness of 32 μm.

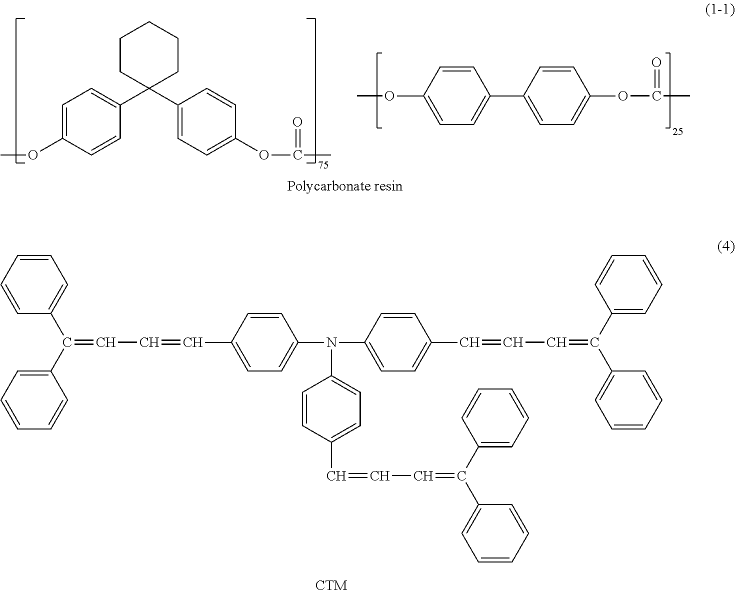

Through the above-described process, a lamination-type electrophotographic photoreceptor of Example 1 is produced.

### Production of Cleaning Blade B1

1,10-decanediol (first polyol component) and 1,4-butanediol (second polyol component) are mixed at a molar ratio of 65/35, and dehydrated and condensed with adipic acid, thereby obtaining a polyester polyol. The polyester polyol is dried under reduced pressure at 75° C. for 15 hours, 59.4 parts of 4,4′-diphenylmethane diisocyanate (MDI, “MILLIONATE MT” manufactured by Tosoh Corporation) with respect to 100 parts of the polyester polyol is added thereto such that a proportion of NCO in the prepolymer is set to 7 mol %, and the mixture is allowed to react at 75° C. for 3 hours in a nitrogen atmosphere, thereby obtaining a prepolymer.

Next, the prepolymer is heated to 100° C. and defoamed under reduced pressure for 1 hour. Thereafter, 7.14 parts of a mixture of 1,4-butanediol and trimethylolpropane (mass ratio=60/40) is added to 100 parts of the prepolymer, and the mixture is mixed for 3 minutes such that bubbles are not generated, thereby preparing a composition B1 for a cleaning blade. Next, the composition B1 for forming a cleaning blade is poured into a centrifugal molding machine having a mold adjusted to 140° C., and allowed to undergo a curing reaction for 1 hour. Next, the resultant is aged and heated at 110° C. for 24 hours, cooled, and cut, thereby obtaining a cleaning blade B1 having a length of 8 mm and a thickness of 1.9 mm.

Impregnation Treatment with Isocyanate

The obtained cleaning blade B1 is dipped in a 4,4′-diphenylmethane diisocyanate (MDI, “MILLIONATE MT” manufactured by Tosoh Corporation, melting point: 38° C.) bath (80° C.) for 1 minute. The cleaning blade is pulled up from the MDI bath and dried in a room temperature environment for 1 minute. Finally, the surface of the cleaning blade is wiped with a sponge containing a small amount of toluene, and dried for another 1 minute.

### Production of Cleaning Blade B2 to B4

Cleaning blades B2 to B4 are produced in the same manner as in the production of the cleaning blade B1 in Example 1, except that the amount [parts] of the isocyanate used in the production of the cleaning blade B1 of Example 1 is changed to the values shown in Table 1, and the presence or absence of the impregnation treatment with an isocyanate is changed as shown in Table 1; and each image forming apparatus is produced.

TABLE 1

| | | With or without 4,4- |
|---|---|---|
| Type of cleaning | Amount of 4,4-diphenylmethane | diphenylmethane diisocyanate |
| blade | diisocyanate [part] | impregnation treatment |
| B1 | 58 | Y |
| B2 | 62 | Y |
| B3 | 58 | N |
| B4 | 48 | N |

### Production of Image Forming Apparatus

An image forming apparatus (“Apeos C7070” manufactured by FUJIFILM Business Innovation Corp.) is mounted with an electrophotographic photoreceptor and the above-described cleaning blade as a cleaning blade for cleaning a surface of the electrophotographic photoreceptor.

The cleaning blade is mounted such that the contact line pressure shown in Table 2 is obtained with respect to the surface of the electrophotographic photoreceptor. The contact angle between the surface of the electrophotographic photoreceptor and the contact portion of the cleaning blade is set to 50°. The above-described image forming apparatus is used as an image forming apparatus of Example 1.

In the table, “PAR” indicates the content of the “polyarylate resin having the dicarboxylic acid unit represented by Formula (A) and the diol unit represented by Formula (B)” in the charge transport layer. In the table, “PC” indicates the content of the “polycarbonate resin” in the charge transport layer. In the table, “PAR/PC” indicates the mass ratio (polyarylate resin/polycarbonate resin) of the polyarylate resin having the dicarboxylic acid unit represented by Formula (A) and the diol unit represented by Formula (B) to the polycarbonate resin, in the charge transport layer. In the table, “Hardness” indicates the micro rubber hardness of the contact portion in contact with the surface of the electrophotographic photoreceptor. In the table, “Contact line pressure” indicates the contact line pressure in a case where the cleaning blade is brought into contact with the surface of the electrophotographic photoreceptor. In the table, “Contact angle” indicates the angle of the contact portion in a case where the cleaning blade is brought into contact with the surface of the electrophotographic photoreceptor.

### Examples 2 to 23, Comparative Examples 1 to 3, and Reference Example 1

Each image forming apparatus is produced in the same manner as in Example 1, except that the amount of the polyarylate resin in the charge transport layer, the type and content of the polycarbonate resin, the mass ratio (PAR/PC) thereof, and the type, contact line pressure, and contact angle of the cleaning blade are set as specifications shown in Table 2.

A structural formula of the polycarbonate resin (1-2) in Table 2 is as follows. The numerical value in the structural formula is a molar ratio.

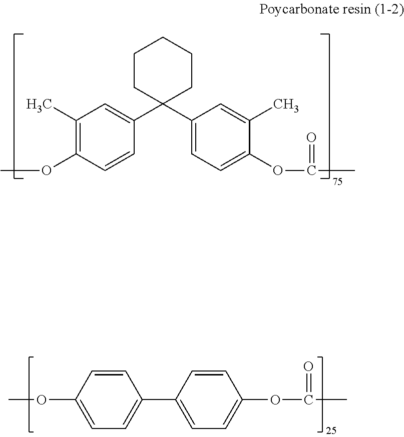

### Evaluation

### Evaluation of Abrasion Resistance

Using the image forming apparatus of each example, 100,000 sheets of an image with an image average density (area coverage) of 10% are formed on A3-sized paper in an environment of a temperature of 22° C. and a relative humidity of 55%, 100,000 sheets are formed in the same manner in an environment of a temperature of 28° C. and a relative humidity of 85%, and then further 100,000 sheets are formed in the same manner in an environment of a temperature of 10° C. and a relative humidity of 15%. An average thickness T_{BEFORE} (μm) of the charge transport layer before the image formation and an average thickness T_{AFTER} (μm) of the charge transport layer after the image formation are obtained, and a difference ΔT (=T_{BEFORE}−T_{AFTER}) is defined as an abrasion amount. PERMASCOPE manufactured by Fisher Instruments K.K. is used as a film thickness measuring machine. The contact line pressure and the contact angle of the cleaning blade with respect to the surface of the electrophotographic photoreceptor in the image forming apparatus are set as shown in the table. The abrasion amount is evaluated according to the following standard. S to C are within an allowable range. The results are shown in the table.

### Evaluation Standard

S: abrasion amount is less than 15 μm.
A: abrasion amount is 15 μm or more and less than 20 μm.
B: abrasion amount is 20 μm or more and less than 25 μm.
C: abrasion amount is 25 μm or more and less than 30 μm.
D: abrasion amount is 30 μm or more.

### Evaluation of Rotational Torque

In each example, 1,000 sheets of A3-sized blank paper (image density: 0%) are continuously output by the image forming apparatus in a high-temperature and high-humidity environment (28° C., 85% RH). In this case, a rotational torque is measured by extracting the drum cartridge from the image forming apparatus before and after the output of 1,000 sheets, and attaching a torque meter (manufactured by Tohnichi Mfg. Co., Ltd.; model number: BTG60CN) to the photoreceptor drive unit and rotating the torque meter. An increase rate of the rotational torque and the presence or absence of blade curling due to the increase in rotational torque of the cleaning blade are evaluated according to the following standard. S to C are within an allowable range. The results are shown in the table.

### Evaluation Standard

S: increase rate of torque is 0% or more and less than 5%, and no curling of the blade occurs.
A: increase rate of torque is 5% or more and less than 10%, and no curling of the blade occurs.
B: increase rate of torque is 10% or more and less than 20%, and no curling of the blade occurs.
C: increase rate of torque is 20% or more and less than 30%, and no curling of the blade occurs.
D: increase rate of torque is 30% or more, and curling of the blade occurs.

TABLE 2

| | | Charge transport layer | | | | Cleaning device | | | | | |
|---|---|---|---|---|---|---|---|---|---|---|---|
| | | PAR | PC | | PAR/PC | | | Contact line | Contact | Evaluation | Evaluation |
| | | Part | Part | PC | Mass | | Hardness | pressure | angle | of abrasion | of rotational |
| | | by mass | by mass | Type | ratio | Type | (°) | NF (gf/mm) | WA (°) | resistance | torque |
| Example | 1 | 30 | 30 | (1-1) | 5/5 | B1 | 86 | 3.0 | 10 | S | S |
| Example | 2 | 12 | 48 | (1-1) | 2/8 | B1 | 86 | 3.0 | 10 | C | A |
| Example | 3 | 18 | 42 | (1-1) | 3/7 | B1 | 86 | 3.0 | 10 | B | A |
| Example | 4 | 42 | 18 | (1-1) | 7/3 | B1 | 86 | 3.0 | 10 | A | B |
| Example | 5 | 48 | 12 | (1-1) | 8/2 | B1 | 86 | 3.0 | 10 | A | C |
| Example | 6 | 54 | 6 | (1-1) | 9/1 | B1 | 86 | 3.0 | 10 | B | B |
| Example | 7 | 30 | 30 | (1-1) | 5/5 | B1 | 86 | 2.4 | 10 | S | B |
| Example | 8 | 30 | 30 | (1-1) | 2/8 | B1 | 86 | 2.4 | 10 | A | A |
| Example | 9 | 48 | 12 | (1-1) | 8/2 | B1 | 86 | 2.4 | 10 | S | C |
| Example | 10 | 54 | 6 | (1-1) | 9/1 | B1 | 86 | 2.4 | 10 | S | C |
| Example | 11 | 30 | 30 | (1-2) | 5/5 | B1 | 86 | 3.0 | 10 | A | A |
| Example | 12 | 30 | 30 | (1-1) | 5/5 | B1 | 86 | 3.5 | 10 | A | A |
| Example | 13 | 30 | 30 | (1-1) | 5/5 | B1 | 86 | 3.5 | 15 | B | B |
| Example | 14 | 30 | 30 | (1-1) | 5/5 | B1 | 86 | 4.0 | 10 | C | C |
| Example | 15 | 30 | 30 | (1-1) | 5/5 | B1 | 86 | 4.0 | 15 | C | C |
| Example | 16 | 30 | 30 | (1-1) | 5/5 | B1 | 86 | 4.5 | 10 | C | C |
| Example | 17 | 30 | 30 | (1-1) | 5/5 | B1 | 86 | 3.0 | 13 | B | A |
| Example | 18 | 30 | 30 | (1-1) | 5/5 | B1 | 86 | 3.0 | 15 | B | B |
| Example | 19 | 30 | 30 | (1-1) | 5/5 | B1 | 86 | 3.0 | 18 | B | C |
| Example | 20 | 30 | 30 | (1-1) | 5/5 | B2 | 91 | 3.0 | 10 | S | S |
| Example | 21 | 30 | 30 | (1-1) | 5/5 | B3 | 78 | 3.0 | 10 | A | A |
| Example | 22 | 30 | 30 | (1-1) | 5/5 | B4 | 75 | 3.0 | 10 | B | A |
| Example | 23 | 55 | 5 | (1-1) | 11/1 | B1 | 86 | 3.0 | 10 | B | C |
| Comparative Example | 1 | 60 | 0 | — | — | B1 | 86 | 3.0 | 10 | D | D |
| Comparative Example | 2 | 0 | 60 | (1-1) | — | B1 | 86 | 3.0 | 10 | D | D |
| Comparative Example | 3 | 30 | 30 | (1-1) | 5/5 | B1 | 86 | 5.0 | 10 | D | D |
| Reference Example | 1 | 30 | 30 | (1-1) | 5/5 | B1 | 86 | 2.2 | 10 | A | S |

As shown in Table 2, it is found that the image forming apparatus of Examples has excellent abrasion resistance even in the medium- and long-term use, and suppresses the increase in rotational torque, as compared with the image forming apparatus of Comparative Examples.

The present exemplary embodiment includes the following aspects.

(((1))) An image forming apparatus comprising:
an electrophotographic photoreceptor in which a conductive substrate, a charge generation layer, and a charge transport layer are laminated in this order;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that has a cleaning blade for cleaning the surface of the electrophotographic photoreceptor with a contact line pressure of 2.4 gf/mm or more and 4.5 gf/mm or less,
wherein the charge transport layer contains a binder resin containing at least a polyarylate resin having a dicarboxylic acid unit represented by Formula (A) and a diol unit represented by Formula (B) and a polycarbonate resin, and contains a charge transport material,

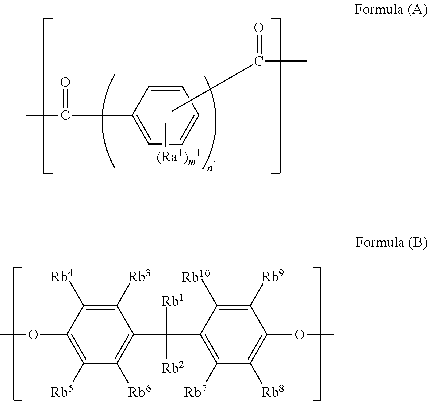

in Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

(((2))) The image forming apparatus according to (((1))),
wherein a mass ratio (polyarylate resin/polycarbonate resin) of the polyarylate resin to the polycarbonate resin is 3/8 or more and 10/1 or less.

(((3))) The image forming apparatus according to (((2))),
wherein the mass ratio (polyarylate resin/polycarbonate resin) of the polyarylate resin to the polycarbonate resin is 4/5 or more and 9/1 or less.

(((4))) The image forming apparatus according to any one of (((1))) to (((3))),
wherein the contact line pressure is 3.0 gf/mm or more and 3.5 gf/mm or less.

(((5))) The image forming apparatus according to any one of (((1))) to (((4))),
wherein a micro rubber hardness of a contact portion of the cleaning blade, that comes into contact with the surface of the electrophotographic photoreceptor, is 85° or more.

(((6))) The image forming apparatus according to any one of (((1))) to (((5))),
wherein a content of the polycarbonate resin with respect to the charge transport layer is 6% by mass or more.

(((7))) The image forming apparatus according to (((6))),
wherein the content of the polycarbonate resin with respect to the charge transport layer is 14% by mass or more and 32% by mass or less.

(((8))) A process cartridge comprising:
an electrophotographic photoreceptor in which a conductive substrate, a charge generation layer, and a charge transport layer are laminated in this order; and
a cleaning device that has a cleaning blade for cleaning a surface of the electrophotographic photoreceptor with a contact line pressure of 2.4 gf/mm or more and 4.5 gf/mm or less,
wherein the charge transport layer contains a binder resin containing at least a polyarylate resin having a dicarboxylic acid unit represented by Formula (A) and a diol unit represented by Formula (B) and a polycarbonate resin,

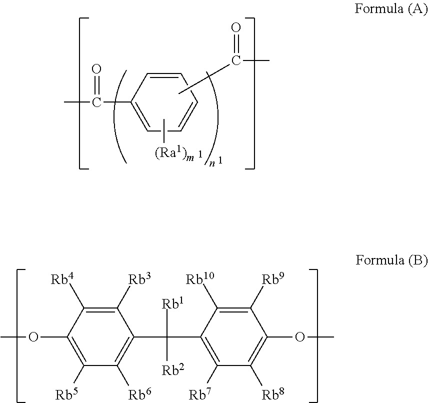

in Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoreceptor in which a conductive substrate, a charge generation layer, and a charge transport layer are laminated in this order;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image;
a transfer device that transfers the toner image to a surface of a recording medium; and
a cleaning device that has a cleaning blade for cleaning the surface of the electrophotographic photoreceptor with a contact line pressure of 2.4 gf/mm or more and 4.5 gf/mm or less,
wherein the charge transport layer contains a binder resin containing at least a polyarylate resin having a dicarboxylic acid unit represented by Formula (A) and a diol unit represented by Formula (B) and a polycarbonate resin, and contains a charge transport material, 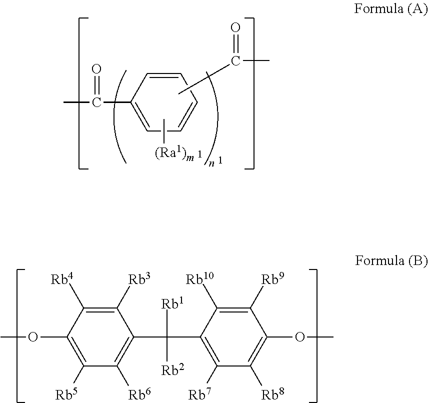
in Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.

2. The image forming apparatus according to claim 1,
wherein a mass ratio (polyarylate resin/polycarbonate resin) of the polyarylate resin to the polycarbonate resin is 3/8 or more and 10/1 or less.

3. The image forming apparatus according to claim 2,
wherein the mass ratio (polyarylate resin/polycarbonate resin) of the polyarylate resin to the polycarbonate resin is 4/5 or more and 9/1 or less.

4. The image forming apparatus according to claim 1,
wherein the contact line pressure is 3.0 gf/mm or more and 3.5 gf/mm or less.

5. The image forming apparatus according to claim 2,
wherein the contact line pressure is 3.0 gf/mm or more and 3.5 gf/mm or less.

6. The image forming apparatus according to claim 1,
wherein a micro rubber hardness of a contact portion of the cleaning blade, that comes into contact with the surface of the electrophotographic photoreceptor, is 85° or more.

7. The image forming apparatus according to claim 2,
wherein a micro rubber hardness of a contact portion of the cleaning blade, that comes into contact with the surface of the electrophotographic photoreceptor, is 85° or more.

8. The image forming apparatus according to claim 1,
wherein a content of the polycarbonate resin with respect to the charge transport layer is 6% by mass or more.

9. The image forming apparatus according to claim 2,
wherein a content of the polycarbonate resin with respect to the charge transport layer is 6% by mass or more.

10. The image forming apparatus according to claim 8,
wherein the content of the polycarbonate resin with respect to the charge transport layer is 14% by mass or more and 32% by mass or less.

11. The image forming apparatus according to claim 9,
wherein the content of the polycarbonate resin with respect to the charge transport layer is 14% by mass or more and 32% by mass or less.

12. A process cartridge comprising:
an electrophotographic photoreceptor in which a conductive substrate, a charge generation layer, and a charge transport layer are laminated in this order; and
a cleaning device that has a cleaning blade for cleaning a surface of the electrophotographic photoreceptor with a contact line pressure of 2.4 gf/mm or more and 4.5 gf/mm or less,
wherein the charge transport layer contains a binder resin containing at least a polyarylate resin having a dicarboxylic acid unit represented by Formula (A) and a diol unit represented by Formula (B) and a polycarbonate resin, 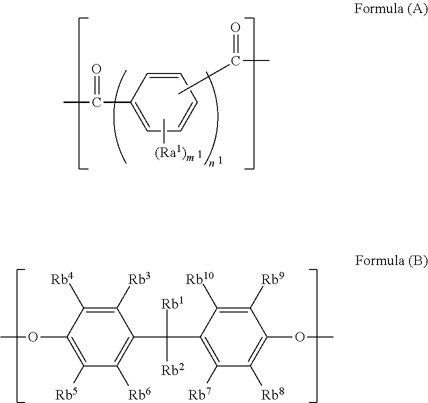
in Formula (A), n¹ is 1, 2, or 3, n¹ pieces of m¹'s are each independently 0, 1, 2, 3, or 4, m¹ pieces of Ra¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms, and Rb¹ and Rb² may be bonded to each other to form a cyclic alkyl group.
